(19) United States
(12) Patent Application Publication
(10) Pub. No.: US 2026/0205180 A1
(43) Pub. Date: Jul. 16, 2026

(54) TECHNIQUES FOR EFFICIENT SIGNALING FOR BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Hamed PEZESHKI, San Diego, CA (US)

(21) Appl. No.: 19/137,604

(22) PCT Filed: Feb. 14, 2023
(86) PCT No.: PCT/CN2023/075824

§ 371 Date: Jun. 10, 2025

(51) Int. Cl. H04B 7/06

(52) U.S. Cl. CPC H04B 7/0626; H04B 7/0695

(57) ABSTRACT

Methods, systems, and devices for wireless communications are described. A user equipment (UE) may receive first control information indicating generation of a channel state information (CSI) report, where the CSI report is for measurement results pertaining to a first set of beams. The UE may receive second control information indicating channel measurement resources (CMRs) and relationship information between one or more second sets of beams and the CMRs. The UE may measure the CMRs to obtain a set of measured results, where the one CMRs are determined based on the relationship information. Based on the measured results of the CMRs, the UE may determine a set of predicted results, where each of the set of predicted results is associated with one of the first set of beams. The UE may transmit the CSI report with the re-Beam ported results that are include at least a subset the set of predicted results.

### CROSS REFERENCE

The present Application is a 371 national phase filing of International PCT Application No. PCT/CN2023/075824 by LI et al., entitled “TECHNIQUES FOR EFFICIENT SIGNALING FOR BEAM PREDICTION,” filed Feb. 14, 2023, which is assigned to the assignee hereof, and which is expressly incorporated by reference in its entirety herein.

### FIELD OF TECHNOLOGY

The following relates to wireless communications, including techniques for efficient signaling for beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for efficient signaling for beam prediction. For example, the described techniques provide for a network entity to indicate, to a user equipment (UE), relationship information between one or more sets of beams and one or more channel measurement resources (CMRs), such that the UE may identify the CMRs out of the one or more sets of beams based on the relationship information, measure the CMRs, and predict measurements for a prediction resource set based on the measurements of the CMRs. In some examples, the UE may receive first control information indicating generation of a channel state information (CSI) report, where the CSI report is for measurement results pertaining to a first set of beams. The UE may receive second control information indicating the one or more CMRs and relationship information between one or more second sets of beams and the CMRs. In such examples, the one or more second sets of beams may be the same as the first set of beams, different from the first set of beams, or a combination thereof. The UE may measure the CMRs to obtain a set of measured results, where the CMRs are identified based on the relationship information. Based on the measured results of the CMRs, the UE may determine a set of predicted results, where each of the set of predicted results is associated with one of the first set of beams. The UE may transmit the CSI report with the reported results that include at least a subset of the set of predicted results.

A method for wireless communication at a UE is described. The method may include receiving first control information that indicates generation, by the UE, of a CSI report that includes reported results that pertain to a first set of beams, receiving second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both, measuring the one or more CMRs to obtain a set of measured results, the one or more CMRs determined based on the relationship information, determining a set of predicted results based on the set of measured results, each of the set of predicted results associated with one of the first set of beams, and transmitting the CSI report with the reported results that are based on at least the set of predicted results.

An apparatus for wireless communication at a UE is described. The apparatus may include a processor, memory coupled with the processor, and instructions stored in the memory. The instructions may be executable by the processor to cause the apparatus to receive first control information that indicates generation, by the UE, of a CSI report that includes reported results that pertain to a first set of beams, receive second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both, measure the one or more CMRs to obtain a set of measured results, the one or more CMRs determined based on the relationship information, determine a set of predicted results based on the set of measured results, each of the set of predicted results associated with one of the first set of beams, and transmit the CSI report with the reported results that are based on at least the set of predicted results.

Another apparatus for wireless communication at a UE is described. The apparatus may include means for receiving first control information that indicates generation, by the UE, of a CSI report that includes reported results that pertain to a first set of beams, means for receiving second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both, means for measuring the one or more CMRs to obtain a set of measured results, the one or more CMRs determined based on the relationship information, means for determining a set of predicted results based on the set of measured results, each of the set of predicted results associated with one of the first set of beams, and means for transmitting the CSI report with the reported results that are based on at least the set of predicted results.

A non-transitory computer-readable medium storing code for wireless communication at a UE is described. The code may include instructions executable by a processor to receive first control information that indicates generation, by the UE, of a CSI report that includes reported results that pertain to a first set of beams, receive second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both, measure the one or more CMRs to obtain a set of measured results, the one or more CMRs determined based on the relationship information, determine a set of predicted results based on the set of measured results, each of the set of predicted results associated with one of the first set of beams, and transmit the CSI report with the reported results that are based on at least the set of predicted results.

In some examples of the method, apparatuses, and non-transitory computer-readable medium described herein, receiving the second control information may include operations, features, means, or instructions for receiving, as at least a portion of the relationship information, a bitmap that identifies the one or more CMRs out of the one or more second sets of beams.

In some examples of the method, apparatuses, and non-transitory computer-readable medium described herein, receiving the second control information may include operations, features, means, or instructions for receiving, as at least a portion of the relationship information, one or more resource identifiers of the one or more second sets of beams, each of the one or more resource identifiers identifying a respective CMR of the one or more CMRs.

In some examples of the method, apparatuses, and non-transitory computer-readable medium described herein, receiving the second control information may include operations, features, means, or instructions for receiving, as at least a portion of the relationship information, a combinatorial index associated with the one or more second sets of beams and identifying the one or more CMRs out of the one or more second sets of beams in accordance with the combinatorial index.

In some examples of the method, apparatuses, and non-transitory computer-readable medium described herein, receiving the second control information may include operations, features, means, or instructions for receiving the second control information via a radio resource control (RRC) message associated with the one or more CMRs, a medium access control-control element (MAC-CE) message that activates the one or more CMRs, or a separate MAC-CE message that may be associated with the CSI report or the one or more CMRs.

In some examples of the method, apparatuses, and non-transitory computer-readable medium described herein, receiving the second control information may include operations, features, means, or instructions for receiving the second control information via a downlink control information (DCI) message that triggers transmission of the CSI report or a separate DCI message that may be associated with the CSI report.

In some examples of the method, apparatuses, and non-transitory computer-readable medium described herein, receiving the second control information may include operations, features, means, or instructions for receiving, as at least a first portion of the relationship information, first relationship information that may be indicative of a first relationship between a first set of the one or more second sets of beams and a first portion of the one or more CMRs and receiving, as at least a second portion of the relationship information, second relationship information that may be indicative of a second relationship between a second set of the one or more second sets of beams and a second portion of the one or more CMRs.

In some examples of the method, apparatuses, and non-transitory computer-readable medium described herein, the first portion of the relationship information may be received via a first CMR control message associated with the first portion of the one or more CMRs and the second portion of the relationship information may be received via a second CMR control message associated with the second portion of the one or more CMRs.

In some examples of the method, apparatuses, and non-transitory computer-readable medium described herein, the first CMR control message may be a RRC message associated with the first portion of the one or more CMRs or a MAC-CE message that activates the first portion of the one or more CMRs and the second CMR control message may be a RRC message associated with the second portion of the one or more CMRs or a MAC-CE message that activates the second portion of the one or more CMRs.

In some examples of the method, apparatuses, and non-transitory computer-readable medium described herein, the first portion of the relationship information and the second portion of the relationship information may be received via a first CMR control message associated with the one or more CMRs.

In some examples of the method, apparatuses, and non-transitory computer-readable medium described herein, the first CMR control message may be a RRC message associated with the one or more CMRs or a MAC-CE message that activates the one or more CMRs and indicates the one or more CMRs being divided into the first portion of the one or more CMRs and the second portion of the one or more CMRs.

In some examples of the method, apparatuses, and non-transitory computer-readable medium described herein, the first set of the one or more second sets of beams may be the same as the first set of beams and the second set of the one or more second sets of beams may be the candidate beam shape set of beams that may be different from the first set of beams.

In some examples of the method, apparatuses, and non-transitory computer-readable medium described herein, transmitting the CSI report may include operations, features, means, or instructions for transmitting, as the reported results, each of the set of predicted results and respective resource identifiers, each of the respective resource identifiers corresponding to a respective beam of the first set of beams.

In some examples of the method, apparatuses, and non-transitory computer-readable medium described herein, transmitting the CSI report may include operations, features, means, or instructions for transmitting, as the reported results, a subset of the set of predicted results and respective resource identifiers, each of the respective resource identifiers corresponding to a respective beam of the first set of beams, where a quantity of the subset of the set of predicted results may be based on a threshold quantity.

Some examples of the method, apparatuses, and non-transitory computer-readable medium described herein may further include operations, features, means, or instructions for receiving beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, where the relationship between the one or more CMRs and the one or more second sets of beams may be based on the beam shape information.

In some examples of the method, apparatuses, and non-transitory computer-readable medium described herein, receiving the beam shape information may include operations, features, means, or instructions for receiving an indication of a beam shape codebook that includes the beam shape information, where the beam shape codebook may be serving cell-specific or may be associated with the first control information and the CSI report.

In some examples of the method, apparatuses, and non-transitory computer-readable medium described herein, the beam shape codebook includes absolute beam shape candidates or relative beam shape candidates.

Some examples of the method, apparatuses, and non-transitory computer-readable medium described herein may further include operations, features, means, or instructions for receiving additional control information that identifies codepoints in the beam shape codebook as the one or more CMRs.

In some examples of the method, apparatuses, and non-transitory computer-readable medium described herein, the first set of beams include synchronization signal blocks (SSBs), CSI reference signals (CSI-RS), or a combination thereof.

In some examples of the method, apparatuses, and non-transitory computer-readable medium described herein, the set of predicted results include a predicted power associated with each of the first set of beams, a predicted signal to noise ratio (SINR) of each of the first set of beams, or both.

A method for wireless communication at a network entity is described. The method may include transmitting first control information that indicates generation, by a UE, of a CSI report that includes reported results that pertain to a first set of beams, transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both, and receiving the CSI report with the reported results that are based on at least a set of predicted results, the set of predicted results being based on a set of measured results of the one or more CMRs, where each of the set of predicted results are associated with one of the first set of beams.

An apparatus for wireless communication at a network entity is described. The apparatus may include a processor, memory coupled with the processor, and instructions stored in the memory. The instructions may be executable by the processor to cause the apparatus to transmit first control information that indicates generation, by a UE, of a CSI report that includes reported results that pertain to a first set of beams, transmit second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both, and receive the CSI report with the reported results that are based on at least a set of predicted results, the set of predicted results being based on a set of measured results of the one or more CMRs, where each of the set of predicted results are associated with one of the first set of beams.

Another apparatus for wireless communication at a network entity is described. The apparatus may include means for transmitting first control information that indicates generation, by a UE, of a CSI report that includes reported results that pertain to a first set of beams, means for transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both, and means for receiving the CSI report with the reported results that are based on at least a set of predicted results, the set of predicted results being based on a set of measured results of the one or more CMRs, where each of the set of predicted results are associated with one of the first set of beams.

A non-transitory computer-readable medium storing code for wireless communication at a network entity is described. The code may include instructions executable by a processor to transmit first control information that indicates generation, by a UE, of a CSI report that includes reported results that pertain to a first set of beams, transmit second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both, and receive the CSI report with the reported results that are based on at least a set of predicted results, the set of predicted results being based on a set of measured results of the one or more CMRs, where each of the set of predicted results are associated with one of the first set of beams.

In some examples of the method, apparatuses, and non-transitory computer-readable medium described herein, transmitting the second control information may include operations, features, means, or instructions for transmitting, as at least a portion of the relationship information, a bitmap that identifies the one or more CMRs out of the one or more second sets of beams.

In some examples of the method, apparatuses, and non-transitory computer-readable medium described herein, transmitting the second control information may include operations, features, means, or instructions for transmitting, as at least a portion of the relationship information, one or more resource identifiers of the one or more second sets of beams, each of the one or more resource identifiers identifying a respective CMR of the one or more CMRs.

In some examples of the method, apparatuses, and non-transitory computer-readable medium described herein, transmitting the second control information may include operations, features, means, or instructions for transmitting, as at least a portion of the relationship information, a combinatorial index associated with the one or more second sets of beams.

In some examples of the method, apparatuses, and non-transitory computer-readable medium described herein, transmitting the second control information may include operations, features, means, or instructions for transmitting the second control information via a RRC message associated with the one or more CMRs, a MAC-CE message that activates the one or more CMRs, or a separate MAC-CE message that may be associated with the CSI report or the one or more CMRs.

In some examples of the method, apparatuses, and non-transitory computer-readable medium described herein, transmitting the second control information may include operations, features, means, or instructions for transmitting the second control information via a DCI message that triggers transmission of the CSI report or a separate DCI message that may be associated with the CSI report.

In some examples of the method, apparatuses, and non-transitory computer-readable medium described herein, transmitting the second control information may include operations, features, means, or instructions for transmitting, as at least a first portion of the relationship information, first relationship information that may be indicative of a first relationship between a first set of the one or more second sets of beams and a first portion of the one or more CMRs and transmitting, as at least a second portion of the relationship information, second relationship information that may be indicative of a second relationship between a second set of the one or more second sets of beams and a second portion of the one or more CMRs.

In some examples of the method, apparatuses, and non-transitory computer-readable medium described herein, the first portion of the relationship information may be received via a first CMR control message associated with the first portion of the one or more CMRs and the second portion of the relationship information may be received via a second CMR control message associated with the second portion of the one or more CMRs.

In some examples of the method, apparatuses, and non-transitory computer-readable medium described herein, the first CMR control message may be a RRC message associated with the first portion of the one or more CMRs or a MAC-CE message that activates the first portion of the one or more CMRs and the second CMR control message may be a RRC message associated with the second portion of the one or more CMRs or a MAC-CE message that activates the second portion of the one or more CMRs.

In some examples of the method, apparatuses, and non-transitory computer-readable medium described herein, the first portion of the relationship information and the second portion of the relationship information may be received via a first CMR control message associated with the one or more CMRs.

In some examples of the method, apparatuses, and non-transitory computer-readable medium described herein, the first CMR control message may be a RRC message associated with the one or more CMRs or a MAC-CE message that activates the one or more CMRs and indicates the one or more CMRs being divided into the first portion of the one or more CMRs and the second portion of the one or more CMRs.

In some examples of the method, apparatuses, and non-transitory computer-readable medium described herein, the first set of the one or more second sets of beams may be the same as the first set of beams and the second set of the one or more second sets of beams may be the candidate beam shape set of beams that may be different from the first set of beams.

In some examples of the method, apparatuses, and non-transitory computer-readable medium described herein, receiving the CSI report may include operations, features, means, or instructions for receiving, as the reported results, each of the set of predicted results and respective resource identifiers, each of the respective resource identifiers corresponding to a respective beam of the first set of beams.

In some examples of the method, apparatuses, and non-transitory computer-readable medium described herein, receiving the CSI report may include operations, features, means, or instructions for receiving, as the reported results, a subset of the set of predicted results and respective resource identifiers, each of the respective resource identifiers corresponding to a respective beam of the first set of beams, where a quantity of the subset of the set of predicted results may be based on a threshold quantity.

Some examples of the method, apparatuses, and non-transitory computer-readable medium described herein may further include operations, features, means, or instructions for transmitting beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, where the relationship between the one or more CMRs and the one or more second sets of beams may be based on the beam shape information.

In some examples of the method, apparatuses, and non-transitory computer-readable medium described herein, transmitting the beam shape information may include operations, features, means, or instructions for transmitting an indication of a beam shape codebook that includes the beam shape information, where the beam shape codebook may be serving cell-specific or may be associated with the first control information and the CSI report.

In some examples of the method, apparatuses, and non-transitory computer-readable medium described herein, the beam shape codebook includes absolute beam shape candidates or relative beam shape candidates.

Some examples of the method, apparatuses, and non-transitory computer-readable medium described herein may further include operations, features, means, or instructions for transmitting additional control information that identifies codepoints in the beam shape codebook as the one or more CMRs.

In some examples of the method, apparatuses, and non-transitory computer-readable medium described herein, the first set of beams include SSB, CSI-RS, or a combination thereof.

In some examples of the method, apparatuses, and non-transitory computer-readable medium described herein, the set of predicted results include a predicted power associated with each of the first set of beams, a predicted SINR of each of the first set of beams, or both.

### BRIEF DESCRIPTION OF THE DRAWINGS

FIG. 1 illustrates an example of a wireless communications system that supports techniques for efficient signaling for beam prediction in accordance with one or more aspects of the present disclosure.

FIG. 2 illustrates an example of a wireless communications system that supports techniques for efficient signaling for beam prediction in accordance with one or more aspects of the present disclosure.

FIG. 3A illustrates an example of a resource diagram that supports techniques for efficient signaling for beam prediction in accordance with one or more aspects of the present disclosure.

FIG. 3B illustrates an example of a resource indication diagram that supports techniques for efficient signaling for beam prediction in accordance with one or more aspects of the present disclosure.

FIG. 4A illustrates an example of a resource diagram that supports techniques for efficient signaling for beam prediction in accordance with one or more aspects of the present disclosure.

FIG. 4B illustrates an example of a resource indication diagram that supports techniques for efficient signaling for beam prediction in accordance with one or more aspects of the present disclosure.

FIG. 5 illustrates an example of a resource diagram that supports techniques for efficient signaling for beam prediction in accordance with one or more aspects of the present disclosure.

FIG. 6 illustrates an example of a process flow that supports techniques for efficient signaling for beam prediction in accordance with one or more aspects of the present disclosure.

FIGS. 7 and 8 illustrate block diagrams of devices that support techniques for efficient signaling for beam prediction in accordance with one or more aspects of the present disclosure.

FIG. 9 illustrates a block diagram of a communications manager that supports techniques for efficient signaling for beam prediction in accordance with one or more aspects of the present disclosure.

FIG. 10 illustrates a diagram of a system including a device that supports techniques for efficient signaling for beam prediction in accordance with one or more aspects of the present disclosure.

FIGS. 11 and 12 illustrate block diagrams of devices that support techniques for efficient signaling for beam prediction in accordance with one or more aspects of the present disclosure.

FIG. 13 illustrates a block diagram of a communications manager that supports techniques for efficient signaling for beam prediction in accordance with one or more aspects of the present disclosure.

FIG. 14 illustrates a diagram of a system including a device that supports techniques for efficient signaling for beam prediction in accordance with one or more aspects of the present disclosure.

FIGS. 15 through 18 illustrate flowcharts showing methods that support techniques for efficient signaling for beam prediction in accordance with one or more aspects of the present disclosure.

### DETAILED DESCRIPTION

In some wireless communications systems, it may be beneficial for a user equipment (UE) to predict measurements of a set of beams (e.g., virtual resources or a prediction resource set) based on measurements of channel measurement resources (CMRs). For example, the UE may receive, from a network entity, the CMRs, perform measurements on the CMRs, and extrapolate the measurement results of the CMRs to predict the measurements of the set of beams. That is, the UE may use the measurements of the CMRs to predict the channel measurements associated with the set of beams without receiving and measuring the set of beams. In order to generate accurate predictions, the UE may perform the prediction using beam information associated with the CMRs and beam information associated with the set of beams, such as beam shape information, spatial information, quasi-co-location (QCL) information, or the like. In some cases, however, using current techniques, the network entity may not be able to signal such information to the UE, resulting in inaccurate prediction results. For example, the network entity may not signal the spatial information, beam information, or QCL information associated with both the set of beam and the CMRs, resulting in inefficient communications.

The techniques, methods, and devices described herein may include mechanisms for signaling a relationship between a first set of beams (e.g., a prediction resource set or a candidate beam shape set) and the CMRs, thereby enabling the UE to accurately predict measurements for the first set of beams based on measured results of the CMRs. For example, the UE may receive a channel state information (CSI) report setting associated with a first set of beams. The UE may also receive control information (e.g., such as downlink control information (DCI), radio resource control (RRC) signaling, or medium access control (MAC) signaling) indicating a relationship between the CMRs to be measured and one or more second sets of beams.

In some examples, the one or more second set of beams may be the same as the first set of beams (e.g., the one or more second set of beams are the first set of beams). In such examples, the relationship between CMRs and the one or more second sets of beams may indicate that the CMRs are a subset of one or more second sets of beams in terms of beam width, beam gain, beam pointing direction, or the like. That is, the relationship information may indicate that the beam widths, beam gains, or beam pointing directions of the CMRs are similar to, or the same as, the beam widths, beam gains, or beam pointing directions of a subset of the first set of beams (e.g., the prediction resource set). As such, the network entity, via the relationship information, may further indicate a bitmap, a combinatorial index, or resource identifiers, such that the UE may identify the CMRs out of the subset of the first set of beams.

In some other examples, the one or more second set of beams may be a candidate beam shape set, where the candidate beam shape set may be different from the first set of beams in terms of beam gain, beam width, beam pointing direction, or the like. In such examples, the relationship information may indicate that the beam widths, beam gains, or beam pointing direction of the CMRs are different from those of the first set of beams, but may indicated that the beam widths, beam gains, or beam pointing directions of the CMRs are similar to, or the same as, a subset of the candidate beam shape set. As such, the network entity, via the relationship information, may further indicate a bitmap, a combinatorial index, or resource identifiers, such that the UE may identify the CMRs out of the subset of the candidate beam shape set.

In some other examples, a first set of the one or more second set of beams may be the same as the first set of beams, while a second set of the one or more second set of beams may be the same as the candidate beam shape set. As such, the relationship information may indicate a first relationship between the CMRs and the first set of beams and a second relationship between the CMRs and the candidate beam shape set. Using such relationship information, the UE may monitor for and receive the CMRs, perform channel measurements of the CMRs, and predict the measurements of the first set of beams. In this way, the UE may receive an indication of the relationship between the CMRs and the first set beams, thereby enabling the UE to accurately perform the predicted measurements without incurring additional overhead in the wireless communications system.

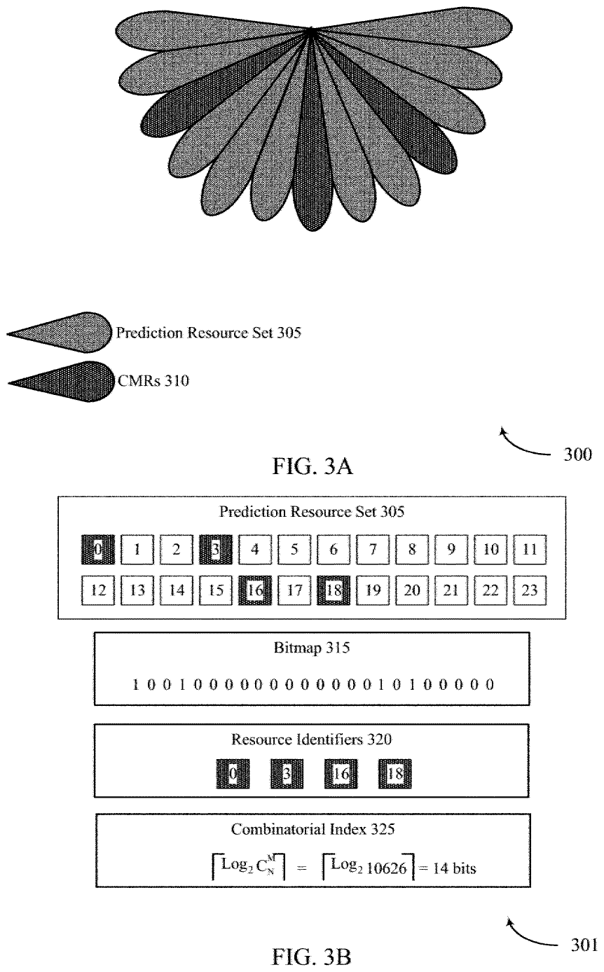

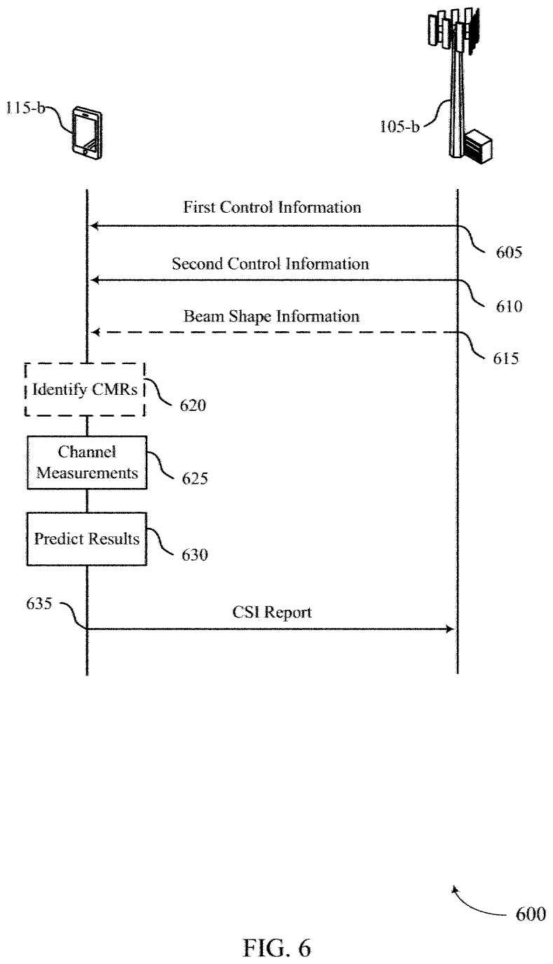

Aspects of the disclosure are initially described in the context of wireless communications systems. Aspects of the disclosure are further described in the context of resource diagrams and resource indication diagrams as described herein with reference to FIGS. 3A through 5. Aspects of the disclosure are further described in the context of a process flow as described herein with reference to FIG. 6. Aspects of the disclosure are further illustrated by and described with reference to apparatus diagrams, system diagrams, and flowcharts that relate to techniques for efficient signaling for beam prediction.

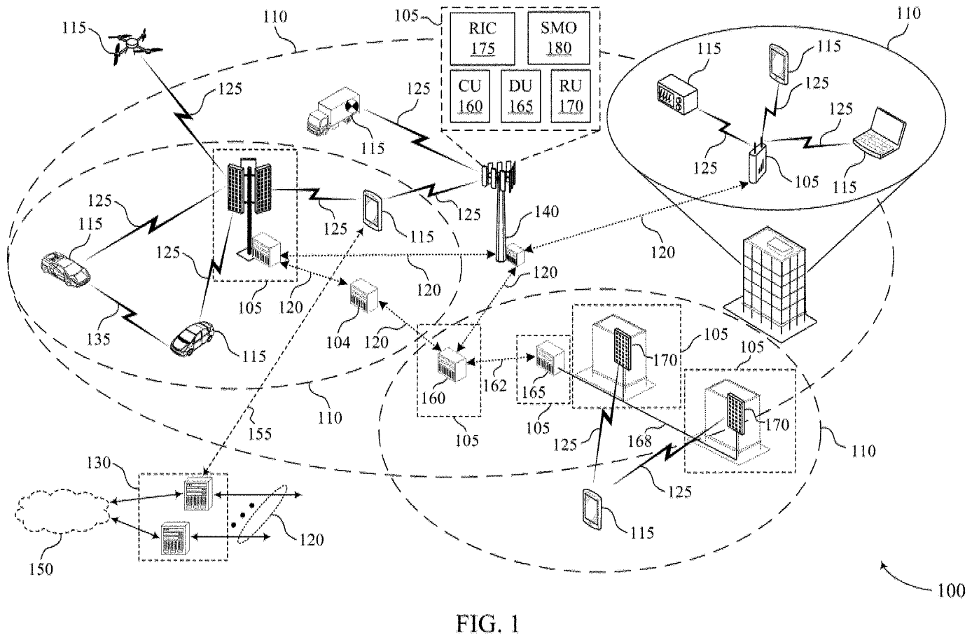

FIG. 1 illustrates an example of a wireless communications system 100 that supports techniques for efficient signaling for beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1 ) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for efficient signaling for beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UE 115 and network entity 105 may communicate data via various beams. For example, the UE 115 may operate in an inactive or idle mode (e.g., RRC inactive or idle mode). The network entity 105 may transmit one or more tracking reference signals (TRSs) to the UE 115, while the UE 115 is operating in such modes. The UE 115 may use such TRSs to perform measurements and track one or more beams of the network entity 105. When the UE 115 has data to be transmitted, the UE 115 may perform an initial access procedure, in order to gain access to the network entity 105. For example, the UE 115 may perform a contention based random access (CBRA) procedure, where the UE 115 may select a random access preamble to use in order to gain access to the network. Further, the UE 115 may receive one or more synchronization signal blocks (SSBs), perform a beam sweeping procedure, and determine a beam to use for communications with the network entity 105.

In response to performing the CBRA procedure, the UE 115 may gain access to the network and perform beam management in order to maintain a connected state (e.g., RRC_CONNECTED state). For example, the UE 115 may perform a sunny day beam management procedure for both uplink and downlink beam management. In downlink beam management (e.g., P1/P2/P3 downlink beam management procedure), the UE 115 may receive one or more reference signals (e.g., SSBs or CSI reference signals (CSI-RSs)) in order to perform and report channel measurements to the network entity 105. In this way, the UE 115 and network entity 105 may perform beam management in the downlink.

For uplink beam management (e.g., U1/U2/U3 uplink beam management procedures) the UE 115 may transmit one or more sounding reference signals (SRSs), such that the network entity 105 may perform channel measurements on such SRSs. In this way, the UE 115 and network entity 105 may perform beam management in the uplink. Further, the UE 115 may report L1 reference signal received power (RSRP) (L1-RSRP), while the network entity 105 may transmit transmission configuration indicator (TCI) state configurations.

In some examples, the UE 115, while operating in the connected mode, may report L1 signal-to-noise ratios (L1-SINRs) of one or more reference signals. In some examples, one or more procedures may be used by the UE 115 or the network entity 105 in order to reduce latency and overhead. For example, component carrier group beam updates, relatively quicker uplink beam updates, unified TCI states, L1 and L2 centric mobility, dynamic TCI updates, uplink multi-panel selection, maximum power extrapolation reduction, a beam management latency reduction, or the like may be implemented to reduce latency in beam management. In some cases, the UE 115 and network entity may perform beam management for multi-transmission and reception points (mTRPs) in the wireless system.

While operating in the connected mode, the UE 115 or network entity 105 may experience beam failure. For example, based on measurements of the SSBs or CSI-RSs in the downlink or SRSs in the uplink, the UE 115 may perform a beam failure recovery procedure in order to reconnect to the network. For example, the UE 115 may implement beam failure detection and beam failure recovery procedures (e.g., for primary and secondary cells of the network entity) in order to reduce latency associated with beam failure. For example, the UE may detect beam failure based on measurements of beam failure detection reference signals and downlink control channel block error rate monitoring. Based on detecting beam failure, the UE 115 may use a contention free random access (CFRA) beam recovery procedure, transmit a link recovery request, or perform a MAC-control element (MAC-CE) beam failure recovery procedure. In some examples, the UE 115 may fail to perform beam failure recovery, which may lead to a radio link failure.

In some examples of the wireless communications system 100, a network entity 105, a UE 115, or both may use artificial intelligence, machine learning, or both for air interface correspondence, in order to target one or more use cases, increase performance, reduce complexity, and provide enhancements to NR systems. An initial set of use cases may include beam management, such as beam prediction in time or spatial domains for overhead and latency reduction, beam selection accuracy improvement, or a combination thereof. Artificial intelligence and machine learning may be used in order to finalize representative sub uses cases for each use case for characterization and baseline performance evaluations. Such approaches (e.g., artificial intelligence and machine learning) for the selected sub use cases may be diverse enough to support various requirements on the network entity 105 to UE 115 (e.g., gNB to UE) collaboration levels. Further, the artificial intelligence and machine learning models and descriptions may identify common and specific characteristics for framework investigations, such as characterize lifecycle management of the artificial intelligence or machine learning model. That is, by using artificial intelligence or machine learning in such use cases, model training, model deployment, model inference, model monitoring, model updating, or a combination thereof may be investigated and implemented in such communications systems.

For example, artificial intelligence and machine learning based beam management techniques may be supported in various scenarios. In a first beam management case (e.g., Beam management case 1), machine learning and artificial intelligence may be used at the network or UE 115 side in order to perform spatial-domain downlink beam prediction for a first set of beams (e.g., set A of beams or a prediction resource set) based on measurement results of a second set of beams (e.g., set B beams or CMRs). In a second beam management case (e.g., Beam management case 2), artificial intelligence or machine learning may be used for temporal downlink beam prediction for the first set of beams based on the historic measurement results of the second set of beams. For either case (e.g., the first or second beam management case), the first and second set of beams may be in the same frequency range (e.g., such as FR1, FR2, or the like).

Further, artificial intelligence or machine learning may be used in a sub-use case of the first beam management case, where, in one example, the second set of beams is a subset of the first set of beams. In such cases, for the UE 115 or network entity 105 to perform such beam predictions, the UE 115 or network entity 105 may have to have an indication of the quantity of beams in both the first and second set of beams and an indication of how to identify the second set of beams out of the first set of beams (e.g., via a fixed pattern, random pattern, or the like). In another sub-use case of the first beam management case, artificial intelligence or machine learning may be used in cases where the first and second set of beams are different (e.g., the first set of beams includes narrow beams, and the second set of beams includes wide beams). In such sub-use cases, for the UE 115 or network entity 105 to accurately perform such beam management, the UE 115 or network entity 105 may have to have an indication of the quantity of beams in the first and second set of beams and an indication of the QCL relation between the first and second set of beams. In such cases, the first set of beams may be for downlink beam prediction and the second set of beams may be for beam measurement. Further, in either beam management case, the codebook constructions of the first and second set of beams may be identified.

In some cases, for the first beam management case, the UE 115 may operate the artificial intelligence or machine learning model (e.g., a UE-side model). In such cases, the UE 115 may transmit L1 signaling to report information of AI/ML model inference to the network entity 105. For example, the UE 115 may report one or more beams that are based on the output of artificial intelligence or machine learning model inference, a predicted L1-RSRP corresponding to each of the one or more beams, among other information. Likewise, for the beam management case 2, the UE 115 may operate the artificial intelligence or machine learning model. In such cases, the UE may transmit L1 signaling to report the information associated with the artificial intelligence and machine learning model inference to the network entity 105. Such information may include one or more beams of N future time instances, where each beam and time instance are based on the output of model inference. The UE 115 may also report, via the L1 signaling, the value of N, a predicted L1-RSRP corresponding to each of the one or more beams, the timestamp corresponding to each of the one or more reported beams (e.g., such information may be explicitly indicated or implicitly determined), among other information.

For either beam management case where the UE 115 operates the artificial intelligence or machine learning mode, the UE 115, the network entity 105, or both may perform model monitoring with potential down-selection. In one example, the UE 115 may perform the model monitoring in order to monitor the performance metrics, perform determinations associated with model selection, activation, deactivation, switching, fallback operations, or the like. In some other cases, the network entity 105 may perform the model monitoring in order to monitor performance metrics, perform determinations of model selection, activation, deactivation, switching, fallback operations, or the like. Additionally, or alternatively, both the network entity 105 and the UE 115 may monitor the model (e.g., hybrid model monitoring), where the UE 115 may monitor the performance metrics, while the network entity 105 may perform determinations of model selection, activation, deactivation, switching, fallback operations, or the like.

Alternatively, for either beam management case, the network entity 105 (e.g., or some network functionalities) may operate the artificial intelligence or machine learning model, where the network entity 105 may perform model monitoring. For example, the network entity 105 may monitor the performance metrics perform determinations of model selection, activation, deactivation, switching, fallback operations, or the like. Further, in cases when the network entity 105 operates the model and performs model monitoring, the network entity 105 may control beam measurement and reporting for model monitoring. For example, if the network entity 105, using either beam management case, is operating the model, the UE 115 may report the measurement results of more than four beams in one reporting instance, where such information may be used by the network entity 105 (e.g., via the model) to perform beam predictions.

For the sub-use cases in both the first and second beam management cases (e.g., spatial or temporal predictions for the first set of beams based on measurements of a second set of beams), the UE 115 and the network entity 105 may at least support model training and inference in cases where the second set of beams are a subset of the first set of beams or the first and second set of beams are different. For example, if the second set of beams are a subset of the first set of beams, then the network entity 105 may perform model training and inference. Alternatively, if the first and second set of beams are different, then the UE 115 may perform model training and inference. In some examples, the UE 115 and network entity 105 may support model transfers between the UE 115 and the network entity 105. For example, the network entity 105 may perform model training, while the UE 115 may perform model inference. In cases where the network entity 105 operates the model in either the first or second beam management case, the UE 115 may report, via L1 signaling, the measurement results of more than four beams in one reporting instance.

Regarding the data collection for the artificial intelligence or machine learning model training at the UE 115 side, the UE 115 or network entity 105 may determine whether and how to initiate data collection, determine configurations related to the first and second set of beams, determine and share information associated with mapping the first and second set of beams. In examples of data collection, the network entity 105 may transmit assistance information to UE 115. In cases where the network entity 105 operates and monitors the model in either beam management case, the UE may report beam measurements based on a set of beams indicated by the network entity 105. Such reporting may be through RRC messaging, L1 signaling, or the like. In such cases, the performance, complexity, and power consumption of the UE 115 may be considered.

In some examples of the wireless communications system 100, it may be beneficial for a UE 115 to predict measurements of a set of beams (e.g., virtual resources or a prediction resource set) based on measurements of CMRs. For example, the UE 115 may receive, from a network entity 105, the CMRs, perform measurements on the CMRs, and extrapolate the measurement results of the CMRs to predict the measurements of the set of beams. That is, the UE 115 may use the measurements of the CMRs to predict the channel measurements associated with the set of beams without receiving and measuring the set of beams. To facilitate such operations, the UE 115 may perform the prediction using beam information associated with the CMRs and beam information associated with the set of beams, such as beam shape information, spatial information, QCL information, or the like, in order for the UE 115 to accurately predict the measurement results. In some cases, however, using current techniques, the network entity 105 may not be able to signal such information to the UE 115, resulting in inaccurate prediction results. For example, the network entity 105 may not signal the spatial information, beam information, or QCL information associated with both the set of beam and the CMRs, resulting in inefficient communications.

The techniques, methods, and devices described herein may include mechanisms for signaling a relationship between a first set of beams (e.g., a prediction resource set) and the CMRs, thereby enabling the UE 115 to accurately predict measurements for the first set of beams based on measured results of the CMRs. For example, the UE 115 may receive a CSI report setting associated with a first set of beams. The UE 115 may also receive control information (e.g., such as DCI, RRC, or MAC signaling) indicating a relationship between the CMRs to be measured and one or more second sets of beams.

In some examples, the one or more second set of beams may be the same as the first set of beams. In such examples, the relationship between CMRs and the one or more second sets of beams may indicate that the CMRs are a subset of one or more second sets of beams in terms of beam width, beam gain, beam pointing direction, or the like. That is, the relationship information may indicate that the beam widths, beam gains, or beam pointing directions of the CMRs are similar to, or the same as, the beam widths, beam gains, or beam pointing directions of a subset of the first set of beams (e.g., the prediction resource set). As such, the network entity 105, via the relationship information, may further indicate a bitmap, a combinatorial index, or resource identifiers, such that the UE 115 may identify the CMRs out of the subset of the first set of resources.

In some other examples, the one or more second set of beams may be a candidate beam shape set, where the candidate beam shape set may be different from the first set of beams in terms of beam gain, beam width, beam pointing direction, or the like. In such examples, the relationship information may indicate that the beam widths, beam gains, or beam pointing direction of the CMRs are different from those of the first set of beams, but may indicate that the beam widths, beam gains, or beam pointing directions of the CMRs are similar to, or the same as, those of the candidate beam shape set. As such, the network entity 105, via the relationship information, may further indicate a bitmap, a combinatorial index, or resource identifiers, such that the UE 115 may identify the CMRs out of the subset of the candidate beam shape set.

In some other examples, a first set of the one or more second set of beams may be the same as the first set of beams, while a second set of the one or more second set of beams may be the candidate beam shape set. As such, the relationship information may indicate a first relationship between the CMRs and the first set of beams and a second relationship between the CMRs and the candidate beam shape set.

The UE 115 may monitor for, receive, and perform channel measurements on, the CMRs. Using such relationship information indicated via the control information, the UE 115 may predict the measurements of the first set of beams based on the measurements of the CMRs. In this way, the UE 115 may receive an indication of the relationship between the CMRs and the first set beams, thereby enabling the UE 115 to perform the predicted measurements.

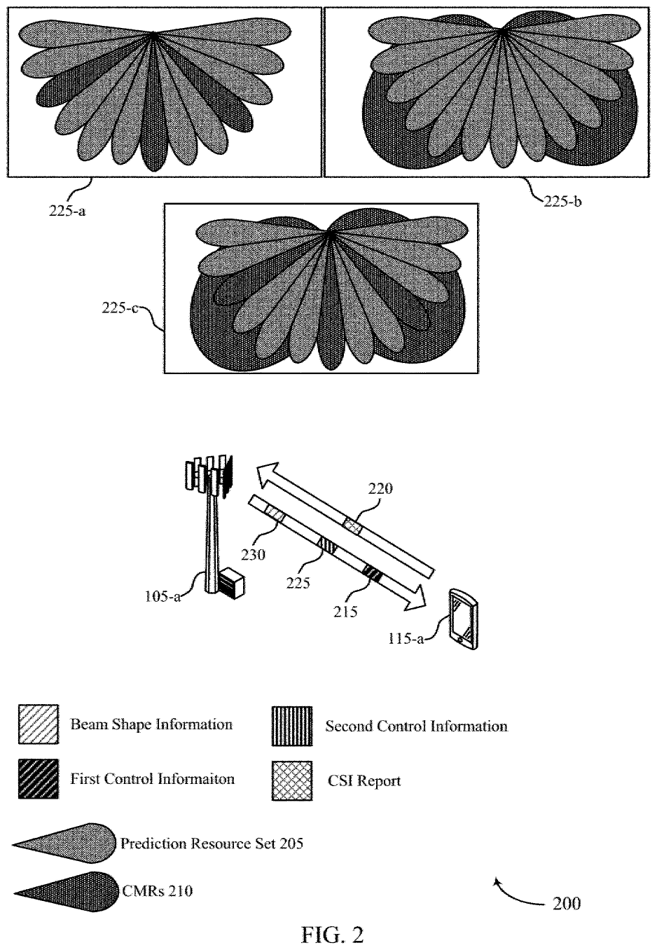

FIG. 2 illustrates an example of a wireless communications system 200 that supports techniques for efficient signaling for beam prediction in accordance with one or more aspects of the present disclosure. The wireless communications system 200 may implement, or be implemented by aspects of the wireless communications system 100. For example, the wireless communications system 200 may include a network entity 105-a and a UE 115-a, which may be examples of corresponding devices described herein with reference to FIG. 1.

In some cases, the UE 115-a, using an artificial intelligence or machine learning model, may predict measurements of a prediction resource set 205 (e.g., a first set of beams, virtual resources, Set A beams) based on measurements of the CMRs 210 (e.g., Set B beams). That is, the UE 115-a may perform spatial-domain downlink beam prediction of the prediction resource set 205 based on measurement results of the CMRs 210 or perform temporal downlink beam prediction for the prediction resource set 205 based on historical measurement results of the CMRs 210. In such cases, the network entity 105-a may transmit the CMRs 210 to the UE 115-a, such that the UE 115-a may perform channel measurements on the CMRs 210 and extrapolate the measurement results to the prediction resource set 205 (e.g., which may or may not be transmitted from the network entity 105-a).

In order to facilitate such beam prediction, the UE 115-a may have to have an indication of the quantity of beams in the prediction resource set 205 and the CMRs 210, an indication of QCL relations between the prediction resource set 205 and the CMRs 210, an indication of how to determine the CMRs 210 out of the prediction resource set 205, or the like. For example, in cases that the CMRs 210 are a subset of the prediction resource set 205 (e.g., in terms of beam width, beam gain, or the like), the UE 115-a may have to have an indication of the connections between the prediction resource set 205 and the CMRs 210 in terms of beam shapes or QCL information to perform accurate beam predictions. However, using current techniques, the network entity 105-a may not have sufficient signaling mechanisms regarding how to indicate such connections (e.g., beam shape, QCL information, or the like) between the CMRs 210 and the prediction resource set 205. That is, in the case that the CMRs 210 are a subset of the prediction resource set 205, the network entity 105-a may not have any mechanisms (e.g., such as bitmaps combinatorial-indices, explicit-indices to identify the CMRs 210, or the like) to signal such a relationship.

Further, such signaling (e.g., if used by the network entity 105-a) should be efficient in terms of downlink overhead, considering that there may be multiple different combinations between the prediction resource set 205 and the CMRs 210 (e.g., in the case of dynamic indications from the network entity 105-a via MAC-CE or DCI signaling). Moreover, the network entity 105-a may not have any signaling mechanisms (e.g., such as CSI report setting, MAC-CE activating the prediction resource set 205 or the CMRs 210, or aperiodic CSI triggering configurations) to indicate such connections between the prediction resource set 205 and the CMRs 210. Further, the network entity 105-a may not have mechanisms to signal (e.g., such as serving cell beam shape codebook or CSI report setting specific beam shape codebook) the absolute or relative beam shapes of candidate resources that may be applied to the prediction resource set 205 and the CMRs 210. As such, if the UE 115-a does not have such information, the UE 115-a may not be able to accurately identify the CMRs 210 out of the prediction resource set 205, thereby leading to inaccuracies in the predicted measurements.

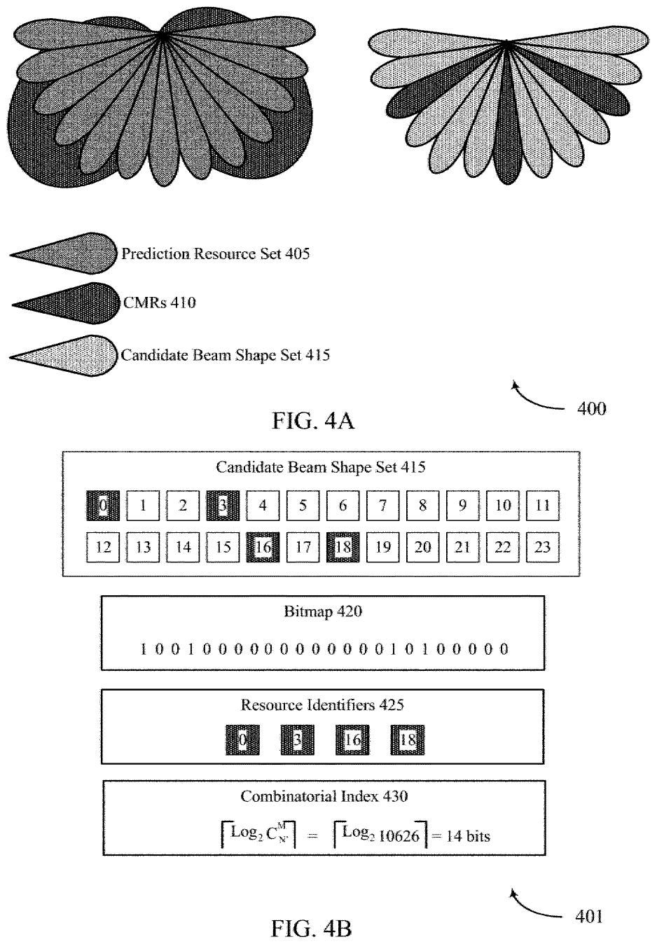

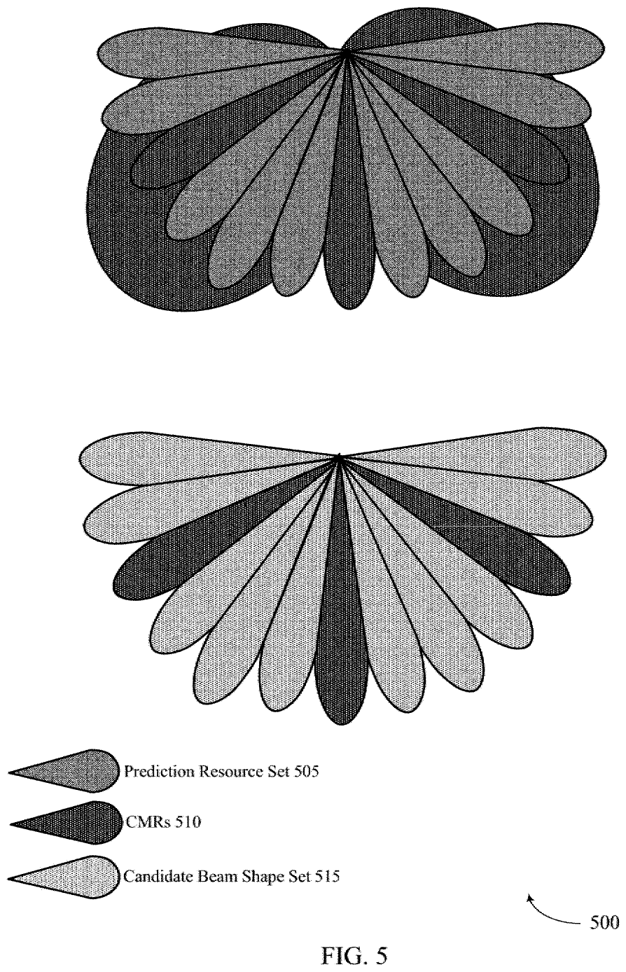

The techniques described herein may provide for signaling designs to enable the network entity 105-a to indicate relationship information between the prediction resource set 205 and the CMRs 210. Such techniques may be applied to scenarios where the CMRs 210 are a subset of the prediction resource set 205, which may be further described herein with reference to FIGS. 3A and 3B. Further, such techniques may be applied to a case where the CMRs 210 may be different from the prediction resource set 205, but may be identified from a candidate beam shape set, which may be further described herein with reference to FIGS. 4A and 4B. In some examples, the techniques may be applied to a case where a first portion of the CMRs 210 are a subset of the prediction resource set 205 and a second portion of the CMRs 210 are a subset of the candidate beam shape set, which may be further described herein with reference to FIG. 5.

That is, the techniques described herein may enable efficient signaling of the CMRs 210 for spatial domain beam predictions of the prediction resource set 205. In some examples, the network entity 105-a may request, via first control information 215, that the UE 115-a predict the L1-RSRPs, the L1-SINRs, or predict measurements for a quantity of resources (e.g., top K resources) of the prediction resource set 205 (e.g., which may be virtual resources), where the prediction resource set 205 is indicated via the first control information 215 (e.g., which may be an example of a CSI report setting). Further, the network entity 105-a, may request, via the first control information 215, for the UE 115-a to report such predicted measurements of the prediction resource set 205, such as report the L1-RSRPs, L1-SINRs, or predicted measurements for the quantity of resources (e.g., top K resources), via a CSI report 220.

For example, the network entity 105-a may transmit the first control information 215 (e.g., CSI report setting) indicating generation of the CSI report 220 by the UE 115-a, such that, via the CSI report 220, the UE 115-a may report one or more results (e.g., predicted measurement results) pertaining to the prediction resource set 205. Further, the first control information 215 may be associated with a quantity of CMRs 210. As such, the network entity 105-a may transmit second control information 225 (e.g., such as RRC signaling, MAC-CE signaling, or DCI signaling) indicating time and frequency resources for the CMRs 210 and indicating relationship information indicative of a relationship between the CMRs 210 and the prediction resource set 205, a relationship between the CMRs 210 and a candidate beam shape set, or a combination thereof. That is, the second control information 225 may indicate one or more second sets of beams (e.g., the prediction resource set 205, a candidate beam shape set, or both) and a relationship between the CMRs 210 and the one or more second sets of beams.

In some examples, the relationship information may indicate that the CMRs 210 may be a subset of the prediction resource set 205. As such, as illustrated in a beam diagram 225-a, the network entity 105-a may indicate, via the relationship information in the second control information 225, that the CMRs 210 and one or more resources in the prediction resource set 205 are connected with each other in terms of absolute or relative beam pointing directions, beam widths, beam gains, or a combination thereof. Such signaling and relationship information associated with the CMRs 210 and the prediction resource set 205 may be further described herein with reference to FIGS. 3A and 3B.

In some other examples, the relationship information may indicate that the CMRs 210 are different from the prediction resource set 205. As such, as illustrated in a beam diagram 225-b, the network entity 105-a may indicate, via the relationship information in the second control information 225, that the CMRs 210 are different from the resources of the prediction resource set 205 in terms of absolute or relative beam pointing directions, beam widths, beam gains, or the like. In such examples, the network entity 105-a may further indicate, via the relationship information in the second control information 225, that the CMRs 210 are associated with, and selected from, a candidate beam shape set (e.g., not shown in FIG. 2). Such signaling and relationship information associated with the CMRs 210 and the candidate beam shape set may be further described herein with reference to FIGS. 4A and 4B.

In some other examples, the relationship information may indicate that a first portion of the CMRs 210 are a subset of the prediction resource set 205, while a second portion of the CMRs 210 are different from the prediction resource set 205, where the second portion of the CMRs 210 may be a subset of the candidate beam shape set. As such, as illustrated in a beam diagram 225-c, the network entity 105-a may indicate, via the second control information 225, first relationship information between the first portion of the CMRs 210 and one or more resources of the prediction resource set 205 and indicate second relationship information between the second portion of the CMRs 210 and one or more resources of the candidate beam shape set. Such signaling and relationship information associated with the CMRs 210, prediction resource set 205, and the candidate beam shape set may be further described herein with reference to FIG. 5.

In some examples of the present disclosure, the prediction resource set 205 may be based on one or more SSBs, CSI-RSs, or a combination thereof, where such resources may be transmitted relatively less frequently than the CMRs 210. In some other examples, the resources in the prediction resource set 205 may not be explicitly transmitted from the network entity 105-a to the UE 115-a. As such, the resources in the prediction resource set 205 may be referred to as virtual resources, where such virtual resources comprise beamforming information. For example, if the prediction resource set 205 are virtual resources, the network entity 105-a may transmit beam shape information 230 associated with the prediction resource set 205, where the beam shape information 230 may include absolute or relative beam pointing directions, beam widths, beam gains, or a combination thereof. Likewise, in cases where the candidate beam shape set are virtual resources, the network entity 105-a may transmit beam shape information 230 associated with the candidate beam shape set.

For example, in order to perform accurate predictions of the prediction resource set 205, the UE 115-a may use beam shape information 230 associated with the prediction resource set 205, the candidate beam shape set, or both, where the beam shape information 230 may include absolute or relative beam pointing directions, beam widths, beam gains, or the like. As such, the UE 115-a may receive the beam shape information 230 identifying beam shapes associated with the prediction resource set 205, the candidate beam shape set, or both.

In some examples, the network entity 105-a may transmit the beam shape information 230 via a codebook framework. For example, the network entity 105-a may transmit, via the beam shape information 230, a beam shape codebook associated with a serving cell, where all possible beam shapes that may be applied to the resources in the prediction resource set 205, in the candidate beam shape set, or a combination thereof, may be pre-configured by a serving cell of the UE 115-a as a codebook.

Additionally, or alternatively, the network entity 105-a may transmit the beam shape information 230 associated with a CSI report setting. As such, the network entity 105-a may indicate, via the beam shape information 230, all possible beam shapes that may be applied to the resources in the prediction resource set 205, applied to the candidate beam shape set, or a combination thereof. In such examples, the network entity 105-a may configure (e.g., and transmit) the beam shape information 230 via RRC signaling associated with the first control information (e.g., the CSI report setting) as a codebook. That is, the network entity 105-a may transmit the beam shape information 230 via a codebook in one or more RRC messages, where each RRC message is associated with the CSI report setting that configures the prediction resource set 205 and the candidate beam shape set. In such examples, the beam shape information 230 may include a beam shape codebook that indicates either absolute beam shape candidates or relative beam shape connections (e.g., beam directions are only indicated relative to each other for different candidates, but no detailed direction information).

In the case that the CMRs 210 are a subset of the prediction resource set 205, the network entity 105-a may transmit the beam shape information 230 via control signaling (e.g., such as RRC signaling, MAC-CE signaling, DCI signaling), where such control signaling is associated with the configuring, activating, and triggering of the prediction resource set 205 and associated with the first control information (e.g., CSI report setting). Such control signaling, including the beam shape information 230, may identify codepoints or indices in the serving cell codebook or CSI report setting codebook, where the UE 115-a may apply such codepoints to the prediction resource set 205. That is, the UE 115-a may receive, or be pre-configured with, (e.g., as defined in a standards document) a beam shape codebook associated with either the serving cell or CSI report setting. The UE 115-a may further receive, in the same or different control signaling, one or more codepoints or indices associated with the beam shape codebook that identifies the associated beam shape information of the prediction resource set 205.

In the case that the CMRs 210 are different from the prediction resource set 205, but may identified from a candidate beam shape set, the UE 115-a may receive, via control signaling, a configuration, activation, or triggering of the candidate beam shape set, where such control signaling may further include codepoints associated with the codebook. In such examples, the beam shape information identified from the serving cell codebook or the CSI report setting codebook may be the candidate beam shape set.

In accordance with the relationship information indicated in the second control information 225 and the beam shape information 230, the UE 115-a may identify, receive, and measure the CMRs 210. As such, the UE 115-a may predict the L1-RSRPs, L1-SINRs, or predict measurement results for the threshold quantity of resources in the prediction resource set 205(e.g., top K resources) based on the relationship information (e.g., connections) between the CMRs 210 and the resources in the prediction resource set 205, on the relationship information (e.g., selection details) between the CMRs 210 and the candidate beam shapes from the candidate beam shape set, or a combination thereof. In some examples, the UE 115-a may perform such beam prediction based on a machine learning or artificial intelligence model.

In response to determining the predicted results of the prediction resource set 205, the UE 115-a may transmit the CSI report 220 indicating at least a subset of the predicted results. In some examples, the UE 115-a may report the predicted L1-RSRPs and L1-SINRs for each resource in the prediction resource set 205 (e.g., each beam of the first set of beams). As such, the UE 115-a may include resource identifiers of the resources in the prediction resource set 205 with the corresponding predicted L1-RSRPs and L1-SINRs. That is, the UE 115-a may include a respective resource identifier for each predicted measurement result, where each of the respective resource identifiers is associated with a respective resource in the prediction resource set 205.

In some other examples, if the UE 115-a reports a subset of predicted results from the prediction resource set 205 (e.g., the top K resources), then the subset of the predicted results may include the strongest predicted L1-RSRPs and L1-SINRs relative to the other predicted results of the prediction resource set 205. For example, the UE 115-a may predict the L1-RSRPs and L1-SINRs for each resource in the prediction resource set 205. Based on an indication of the threshold quantity of reported results in the first control information, the UE 115-a may report up to the threshold quantity of the predicted results, where the threshold quantity includes the relatively strongest predicted L1-RSRPs and L1-SINRs. As an illustrative example, the network entity 105-a may indicate for the UE 115-a to report the top three predicted results of the prediction resource set 205. As such, the UE 115-a may predict the measurements for each resource in the prediction resource set 205 and select the three strongest predicted resources out of the prediction resource set 205. In such examples, the UE 115-a may include the resource identifiers associated with the three predicted results.

FIGS. 3A and 3B illustrates an example of a resource diagram 300 and a resource indication diagram 301, respectively, that support techniques for efficient signaling for beam prediction in accordance with one or more aspects of the present disclosure. The resource diagram 300 and the resource indication diagram 301 may be implement, or be implemented by, aspects of the wireless communications system 100 and the wireless communications system 200 as described herein with reference to FIGS. 1 through 2. For example, the resource diagram 300 and resource indication diagram 301 may be implemented by a UE 115, a network entity 105, or both.

Further, the resource diagram 300 may include a prediction resource set 305 and CMRs 310, which may be examples of a prediction resource set 205 and CMRs 210. The network entity 105 may use one of the indication techniques (e.g., a bitmap 315, resource identifiers 320, and a combinatorial index 325), as shown in the resource indication diagram 301, to indicate the CMRs 310 out of the prediction resource set 305. The resource diagram 300 and the resource indication diagram 301 may be implemented by such devices (e.g., a network entity 105 or UE 115) in cases when one or more CMRs 310 are a subset of the prediction resource set 305 in terms of beam shapes.

For example, the network entity 105 may transmit first control information (e.g., a CSI report setting) requesting the UE 115 to perform beam prediction for the prediction resource set 305 based on measurements of the CMRs 310. As such, in the example of the resource diagram 300, the CMRs 310 may be a subset of the prediction resource set 305 in terms of beam shapes. That is, the beam shapes, such as beam pointing direction, beam width, beam gain, or the like, of the transmitted CMRs 310 may be similar to, or the same as, beam shapes of a subset of the prediction resource set 305 indicated in the first control information.

In accordance with aspects described herein, the network entity 105 may transmit relationship information between the CMRs 310 and the prediction resource set 305. For example, the network entity 105 may transmit the first control information (e.g., a CSI report setting) indicating the absolute or relative beam pointing directions, beam widths, beam gains, of a first quantity of resources in the prediction resource set 305 (e.g., network entity 105 indicates N resources in the prediction resource set 305 via the CSI report setting). After, or concurrently with, transmitting the first control information, the network entity 105 may transmit second control information (e.g., such as RRC signaling, MAC-CE signaling, DCI signaling) indicating a quantity of CMRs 310 (e.g., indicating M CMRs 310) and indicating the absolute or relative beam pointing directions, beam widths, beam gains, or the like of the CMRs 310.

In order to indicate the beam shape information of the quantity of CMRs 310, the network entity 105 may include, in the second control signaling, relationship information between the prediction resource set 305 and the CMRs 310, where such relationship information indicates a selection of a subset of resources (e.g., M resources) out of the quantity of resources (e.g., N resources) in the prediction resource set 305. That is, each CMR 310 may be associated with a respective resource of the prediction resource set 305. To indicate such relationship information (e.g., the indication of M resources out of N resources of the prediction resource set 305, where the M resources represent the CMRs 310), the network entity 105 may transmit one of the resource indication techniques as shown in the resource indication diagram 301.

In one example, the network entity 105 may transmit, via the second control information and as part of the relationship information, the bitmap 315 with a length equal to the quantity of resources in the prediction resource set 305 (e.g., the bitmap 315 has a length of N or N quantity of bits). As such, each bit in the bitmap 315 may be associated with a resource in the prediction resource set 305. In order to indicate the CMRs 310 out of the prediction resource set 305, the network entity 105 may indicate a one in the bit position associated with the CMRs 310. As an illustrative example, if the prediction resource set 305 include 24 resources (e.g., 0 through 23), the network entity 105 may indicate that resources 0, 3, 16, and 18 are related to the CMRs 310 in terms of beam shape information. As such, via the bitmap 315, the network entity 105 may indicate a one in the most significant bit (MSB) of the bitmap 315, where the MSB in the bitmap 315 may be associated with resource 0 of the prediction resource set 305. Further, the network entity 105 may include a one, in subsequent bits in the bitmap 315, to indicate that the third, sixteenth, and eighteenth resources of the prediction resource set 305 are related to the CMRs 310. It should be understood that such an illustrative example is not a representative of all the means and ways for which the network entity 105-a may indicate the relationship information via the bitmap 315.

In another example, the network entity 105 may transmit, via the second control information and as part of the relationship information, the resource identifiers 320 of the prediction resource set 305 that are related to the CMRs 310. That is, the network entity 105 may use the resource identifiers 320 to explicitly indicate the quantity of CMRs 310 out of the quantity of resources in the prediction resource set 305 (e.g., indicate M resources out of the N resources). The network entity 105 may use a quantity of bits in order to indicate the resource identifiers. For example, to determine the quantity of bits, the network entity may take the log base two of the quantity of resources in the prediction resource set 305. As an illustrative example, if the prediction resource set 305 includes 24 resources and the CMRs 310 are associated with resource 0, resource 3, resource 16, and resource 18, the network entity 105 may transmit, via the second control information and as part of the relationship information, the resource identifiers 320 associated with the resource 0, resource 3, resource 16, and resource 18. As such, each resource identifier may be represented by five bits (e.g., ┌log₂ 24┐=5).

In another example, the network entity 105 may transmit, via the second control information and as part of the relationship information, a

$${C}_{N}^{M}$$

combinatorial index 325 (e.g., via

$$⌈ {log}_{2} {C}_{N}^{M} ⌉$$

bits), where the combinatorial index 325 may be used by the UE 115 to choose the quantity of CMRs 310 (e.g., M resource identifiers) out of the quantity of resources in the prediction resource set 305 (e.g., N resources). Here the first, second, and third selected resources of the prediction resource set 305 may be mapped to the first, second, and third resources in the CMRs 310.

As described herein, the network entity 105 may transmit such relationship information (e.g., the bitmap 315, resource identifiers 320, combinatorial index 325) via RRC signaling, MAC-CE signaling, DCI signaling, or a combination thereof. In the example of RRC signaling, the relationship information may be indicated via a configuration in the first control information (e.g., CSI report setting) or via a configuration in the second control information (e.g., via a configuration for the CMRs 310), where the second control information is associated with the first control information (e.g., CSI report setting).

In the example of MAC-CE signaling, the relationship information may be indicated via MAC-CE signaling activating a semi-persistent CSI report with respect to the first control information (e.g., CSI report setting) or by MAC-CE signaling activating the second control information (e.g., the semi-persistent CMRs 310 associated with the CSI report setting). Further, the relationship information may be indicated in a separate MAC-CE that includes an identifier of the first control information (e.g., the CSI report setting identifier) or an identifier of the second control information (e.g., the CMRs 310 identifier).

In the example of the DCI signaling, the relationship information may be indicated via a CSI report parameter (e.g., CSI-AssociatedReportConfigInfo) in the first control information (e.g., a aperiodic CSI report setting), where such relationship information may be triggered by the DCI requesting the aperiodic CSI report associated with the first control information (e.g., aperiodic CSI report setting). In some other examples, the relationship information may be indicated via one or more dedicated fields in a DCI that may be associated with the first control information (e.g., CSI report setting), where such first control information (e.g., CSI report setting) is indicated in the DCI. Such dedicated DCI fields may also include an identifier associated with the first control information (e.g., a CSI report setting identifier) or an identifier associated with the second control information (e.g., an identifier associated with the CMRs 310).

FIGS. 4A and 4B illustrate examples of a resource diagram 400 and a resource indication diagram 401 that support techniques for efficient signaling for beam prediction in accordance with one or more aspects of the present disclosure. The resource diagram 400 and the resource indication diagram 401 may be implement, or be implemented by, aspects of the wireless communications system 100, the wireless communications system 200, the resource diagram 300, and the resource indication diagram 301 as described herein with reference to FIGS. 1 through 3B. For example, the resource diagram 400 and the resource indication diagram 401 may be implemented by a UE 115, a network entity 105, or both.

The resource diagram 400 may include a prediction resource set 405 and CMRs 410, which may be examples of corresponding resources as described herein. Further, resource diagram 400 may include a candidate beam shape set 415, which may be an example of the candidate beam shape sets described herein with reference to FIG. 2. The resource indication diagram 401 may include a bitmap 420, resource identifiers 425, and a combinatorial index 430, which may be examples of corresponding indication techniques as described herein with reference to FIG. 3B.

The network entity 105 may use one of the indication techniques (e.g., the bitmap 420, resource identifiers 425, or the combinatorial index 430), as shown in the resource indication diagram 401, to indicate the CMRs 410 out of the candidate beam shape set 415. As such, the resource diagram 400 and the resource indication diagram 401 may be implemented by such devices (e.g., a network entity 105 or UE 115) in cases when one or more CMRs 410 are different from the prediction resource set 405 in terms of beam shapes, but the beam shapes of the one or more CMRs 410 may be associated with a candidate beam shape set 415.

For example, the network entity 105 may transmit first control information (e.g., a CSI report setting) requesting the UE 115 to perform beam prediction for the prediction resource set 405 based on measurements of the CMRs 410. As such, in the example of the resource diagram 400, CMRs 410 are different from the prediction resource set 405 in terms of beam shapes, but the beam shapes of the one or more CMRs 410 may be associated with a candidate beam shape set 415. That is, the beam shapes, such as beam pointing direction, beam width, beam gain, or the like, of the transmitted CMRs 410 may not have a direct connection with the beam shapes of the prediction resource set 405 indicated in the first control information. However, the CMRs 410 may be similar to, or the same as, a subset of the candidate beam shape set 415 and be selected from the candidate beam shape set 415.

In accordance with aspects described herein, the network entity 105 may transmit relationship information between the CMRs 410 and the candidate beam shape set 415. For example, the network entity 105 may transmit first control information (e.g., a CSI report setting) indicating the absolute or relative beam pointing directions, beam widths, beam gains, of a first quantity of resources in the candidate beam shape set 415 (e.g., network entity 105 indicates N′ resources in the candidate beam shape set 415 via the CSI report setting). In such examples, the first control information may also include an indication of the prediction resource set 405.

After, or concurrently with, transmitting the first control information, the network entity 105 may transmit second control information (e.g., such as RRC signaling, MAC-CE signaling, DCI signaling) indicating a quantity of CMRs 410 (e.g., indicating M CMRs 410) and indicating the absolute or relative beam pointing directions, beam widths, beam gains, or the like of the CMRs 410.

In order to indicate the beam shape information of the quantity of CMRs 410, the network entity 105 may include, in the second control information, relationship information between the candidate beam shape set 415 and the CMRs 410, where such relationship information indicates a selection of a subset of resources (e.g., M resources) out of the quantity of resources (e.g., N′ resources) in the candidate beam shape set 415. That is, the beam shape of each CMR 410 may be associated with a respective resource of the candidate beam shape set 415. To indicate such relationship information (e.g., the indication of M resources out of N′ resources of the candidate beam shape set 415, where the M resources represent the CMRs 410), the network entity 105 may transmit one of the resource indication techniques as shown in the resource indication diagram 401.

In one example, the network entity 105 may transmit, via the second control information and as part of the relationship information, the bitmap 420 with a length equal to the quantity of resources in the candidate beam shape set 415 (e.g., a length N′ bitmap 420). As such, each bit in the bitmap 420 may be associated with a resource in the candidate beam shape set 415. In order to indicate the CMRs 410 out of the candidate beam shape set 415, the network entity 105 may indicate a one in the bit position associated with the CMRs 410. As an illustrative example, if the candidate beam shape set 415 include 24 resources (e.g., 0 through 23), the network entity 105 may indicate that resources 0, 3, 16, and 18 are related to the CMRs 410 in terms of beam shape information. As such, via the bitmap 420, the network entity 105 may indicate a one in the MSB of the bitmap 420, where the MSB in the bitmap 420 may be associated with resource 0 of the candidate beam shape set 415. Further, the network entity 105 may include a one, in subsequent bits in the bitmap 420, to indicate that the third, sixteenth, and eighteenth resources of the candidate beam shape set 415 are related to the CMRs 410 in terms of beam shape.

In another example, the network entity 105 may transmit, via the second control information and as part of the relationship information, the resource identifiers 425 (e.g., the shape identifiers) of the candidate beam shape set 415 that are related to the CMRs 410. That is, the network entity 105 may use the resource identifiers 425 to explicitly indicate the quantity of CMRs 410 out of the quantity of resources in the candidate beam shape set 415 (e.g., indicate M resources out of the N′ resources). The network entity 105 may use a quantity of bits in order to indicate the resource identifiers. For example, to determine the quantity of bits, the network entity 105 may take the log base two of the quantity of resources in the candidate beam shape set 415. As an illustrative example, if the candidate beam shape set 415 includes 24 resources and the beam shapes of the CMRs 410 are associated with the beam shapes of resource 0, resource 3, resource 16, and resource 18, the network entity 105 may transmit, via the second control information and as part of the relationship information, the resource identifiers 425 associated with the resource 0, resource 3, resource 16, and resource 18. As such, each resource identifier may be represented by five bits (e.g., ┌log₂ 24┐=5).

In another example, the network entity 105 may transmit, via the second control information and as part of the relationship information, a

$${C}_{{N}^{′}}^{M}$$

combinatorial index 430 (e.g., via

$$⌈ {log}_{2} {C}_{{N}^{′}}^{M} ⌉$$

bits), where the combinatorial index 430 may be used by the UE 115 to choose the quantity of CMRs 410 (e.g., M shape identifiers) out of the quantity of resources in the candidate beam shape set 415 (e.g., N′ shape resources). Here the first, second, and third selected resources of the candidate beam shape set 415 may be mapped to the first, second, and third resources in the CMRs 410.

As described herein, the network entity 105 may transmit such relationship information (e.g., the bitmap 420, resource identifiers 425, or the combinatorial index 430) via RRC signaling, MAC-CE signaling, DCI signaling, or a combination thereof. In the example of RRC signaling, the relationship information may be indicated via a configuration in the first control information (e.g., CSI report setting) or via a configuration in the second control information (e.g., via a configuration for the CMRs 410), where the second control information is associated with the first control information (e.g., CSI report setting).

In the example of MAC-CE signaling, the relationship information may be indicated via MAC-CE signaling activating a semi-persistent CSI report with respect to the first control information (e.g., CSI report setting) or by MAC-CE signaling activating the second control information (e.g., the semi-persistent CMRs 410 associated with the CSI report setting). Further, the relationship information may be indicated in a separate MAC-CE that includes an identifier of the first control information (e.g., the CSI report setting identifier) or an identifier of the second control information (e.g., the CMRs 410 identifier).

In the example of the DCI signaling, the relationship information may be indicated via a CSI report parameter (e.g., CSI-AssociatedReportConfigInfo) in the first control information (e.g., a aperiodic CSI report setting), where such relationship information may be triggered by the DCI requesting the aperiodic CSI report associated with the first control information (e.g., aperiodic CSI report setting). In some other examples, the relationship information may be indicated via one or more dedicated fields in a DCI that is associated with the first control information (e.g., CSI report setting), where such first control information (e.g., CSI report setting) is indicated in the DCI. Such dedicated DCI fields may also include an identifier associated with the first control information (e.g., a CSI report setting identifier) or an identifier associated with the second control information (e.g., an identifier associated with the CMRs 410).

FIG. 5 illustrates an example of a resource diagram 500 that supports techniques for efficient signaling for beam prediction in accordance with one or more aspects of the present disclosure. The resource diagram 500 may be implement, or be implemented by, aspects of the wireless communications system 100, the wireless communications system 200, the resource diagram 300, the resource indication diagram 301, the resource diagram 400, and the resource indication diagram 401 as described herein with reference to FIGS. 1 through 4B. For example, the resource diagram 500 may be implemented by a UE 115, a network entity 105, or both. The resource diagram 500 may include a prediction resource set 505, CMRs 510, and a candidate beam shape set 515, which may be examples of corresponding resources as described herein.

In some examples, the network entity 105 may transmit first control information (e.g., a CSI report setting) requesting the UE 115 to perform beam prediction for the prediction resource set 505 based on measurements of the CMRs 510. As such, in the example of the resource diagram 500, a first portion of the CMRs 510 may be a subset of the prediction resource set 505 in terms of beam shapes, while a second portion of the CMRs 510 may be a subset of the candidate beam shape set 515 in terms of beam shapes. That is, a first portion of the beam shapes, such as beam pointing direction, beam width, beam gain, or the like, of the transmitted CMRs 510 may be a subset of the prediction resource set 505, while the second portion of beam shapes (e.g., the remaining portion) of the transmitted CMRs 510 may have no direct connections with the resources in the prediction resource set 505. As such, the beam shapes of the second portion of the CMRs 510 may be the same as, or similar to, those of the candidate beam shape set 515.

In such examples, the UE 115 may receive relationship information (e.g., connections) between the first portion of the CMRs 510 and the prediction resource set 505 in accordance with the techniques described herein with reference to FIGS. 3A and 3B, while receiving separate signaling for relationship information between the second portion of the CMRs 510 and the candidate beam shape set 515 in accordance with the techniques described herein with reference to FIGS. 4A and 4B.

In some examples, the first and second portions of the CMRs 510 may be associated with a first set of CMRs 510 and a second set of CMRs 510, respectively, where both the first set of CMRs 510 and the second set of CMRs 510 may be indicated via second control information that is associated with the first control information indicating both the prediction resource set 505 and the candidate beam shape set 515 (e.g., the CSI report setting). For example, the network entity 105 may transmit first control information indicating generation of a CSI report that includes predicted results pertaining to the prediction resource set 505. In the first control information, the network entity 105 may indicate resources of the prediction resource set 505 (e.g., virtual or otherwise), resources of the candidate beam shape set 515, or both.

As such, the network entity 105 may indicate first relationship information (e.g., connection) between the first portion of CMRs 510 (e.g., the first set of CMRs 510) and the prediction resource set 505 via RRC signaling indicating the first portion of CMRs 510 (e.g., indicating the first set of CMRs 510). In some other examples, the network entity 105 may indicate the first relationship (e.g., connection) between the first portion of CMRs 510 (e.g., the first set of CMRs 510) and the prediction resource set 505 via MAC-CE signaling that activates the first portion of the CMRs 510. Additionally, the network entity 105 may separately transmit second relationship information between the beam shapes of the second portion of the CMRs 510 (e.g., the second set of CMRs 510) and the candidate beam shape set 515 via RRC signaling indicating the second portion of the CMRs 510. In some other examples, the network entity 105 may indicate the second relationship information (e.g., connection) between the second portion of CMRs 510 (e.g., the second set of CMRs 510) and the candidate beam shape set 515 via MAC-CE signaling that activates the second semi-persistent portion of the CMRs 510.

That is, after, or concurrently, with transmitting the first control information, the network entity 105 may transmit a first RRC or MAC-CE message indicating the first portion of CMRs 510 (e.g., the first set of CMRs 510) and indicating the relationship between the first portion of CMRs 510 and the prediction resource set 505 and transmit a second RRC or MAC-CE message indicating the second portion of CMRs 510 (e.g., the second set of CMRs 510) and indicating the relationship between the second portion of the CMRs 510 and the candidate beam shape set 515.

In such examples, the first and second relationship information may also include respective bitmaps, resource identifiers, combinatorial indices, or the like. As such, the UE 115 may identify the first portion of the CMRs 510 out of the prediction resource set 505 in accordance with the techniques described herein with reference to FIGS. 3A and 3B. Further. the UE 115 may identify the second portion of the CMRs 510 out of the candidate beam shape set 515 in accordance with the techniques described herein with reference to FIGS. 4A and 4B.

In some other examples, the first portion of CMRs 510 and the second portion of the CMRs 510 may be indicated via a single set of CMRs 510. As such, the network entity 105 may transmit second control information (e.g., such as an RRC configuration) indicating the single set of CMRs 510, where such second control information may further indicate the separation between the first and second portions of the single set of CMRs 510. For example, the network entity 105 may transmit a single control message indicating first relationship information (e.g., a first connection) between the first portion of CMRs 510 and the prediction resource set 505, in addition to, second relationship information (e.g., a second connection) between the beam shapes of the second portion of CMRs 510 and the candidate beam shape set 515. In such examples, network entity 105 may transmit an RRC message indicating the single set of CMRs 510 and the first and second relationship information. Alternatively, the network entity 105 may transmit a MAC-CE signal that activates the semi-persistent CMRs 510 and further indicates the first and second relationship information.

In such examples, the first and second relationship information may also include respective bitmaps, resource identifiers, combinatorial indices, or the like. As such, the UE 115 may identify the first portion of the CMRs 510 out of the prediction resource set 505 in accordance with the techniques described herein with reference to FIGS. 3A and 3B. Further. the UE 115 may identify the second portion of the CMRs 510 out of the candidate beam shape set 515 in accordance with the techniques described herein with reference to FIGS. 4A and 4B.

FIG. 6 illustrates an example of a process flow 600 that supports techniques for efficient signaling for beam prediction in accordance with one or more aspects of the present disclosure. The process flow 600 may implement, or be implemented by, aspects of the wireless communications system 100, the wireless communications system 200, the resource diagram 300, the resource indication diagram 301, the resource diagram 400, the resource indication diagram 401, and the resource diagram 500 as described herein with reference to FIGS. 1 through 5. For example, the process flow 600 may include a UE 115-b and a network entity 105-b, which may be examples of corresponding devices described herein. In the following description of the process flow 600, the operations may be performed in a different order than the order shown. Specific operations also may be left out of the process flow 600, or other operations may be added to the process flow 600. Further, although some operations or signaling may be shown to occur at different times for discussion purposes, these operations may actually occur at the same time.

At 605, the UE 115-b may receive, from the network entity 105-b, first control information that indicates generation, by the UE 115-b, of a CSI report that includes reported results that pertain to a first set of beams. The first set of beams may be examples of a prediction resource set as described herein. In some examples, the UE 115-b may receive an indication of a candidate beam shape set via the first control information. The first control information may be an example of a CSI report setting.

At 610, the UE 115-b may receive second control information indicating one or more CMRs and relationship information that indicates a relationship (e.g., a connection) between one or more second sets of beams and the one or more CMRs. The one or more second sets of beams may be the same as the first set of beams, may be a candidate beam shape set that is different from the first set of beams, or a combination thereof.

That is, the relationship information may indicate that the one or more CMRs are a subset of the first set of beams (e.g., CMRs are a subset of the prediction resource set) as described herein with reference to FIGS. 3A and 3B. In some examples, the relationship information may indicate that the one or more CMRs are different from the first set of beams, but may be a subset of the candidate beam shape set as described herein with reference to FIGS. 4A and 4B. In some other examples, the second control information may include first relationship information associated with a first portion of the CMRs that are a subset of the first set of beams, and include second relationship information associated with a second portion of the CMRs that are a subset of the candidate beam shape set, as described herein with reference to FIG. 5. The relationship information may also include a bitmap, resource identifiers, or combinatorial indices as described herein.

At 615, the UE 115-b may receive beam shape information associated with the first set of beams, the candidate beam shape set, or both. In some examples, the beam shape information may include absolute or relative beam pointing directions, beam gains, beam widths, or the like. The beam shape information may be associated with one or more codebooks as described herein with reference to FIG. 2.

At 620, in accordance with the relationship information and beam shape information, the UE 115-b may identify the beam shapes of the one or more CMRs. At 625, the UE 115-b may measure the one or more CMRs to obtain a set of measured results. The set of measured results may be the L1-RSRP or L1-SINR of the CMRs.

At 630, the UE 115-b may determine a set of predicted results based on the set of measured results, where each of the set of predicted results is associated with the first set of beams. That is, the UE 115-b may use the measurements of the CMRs to predict the measurements of the first set of beams. Such predicted results may be the L1-RSRP and L1-SINR of the first set of beams.

At 635, the UE 115-b may transmit the CSI report that includes the reported results. In some examples, the reported results include each of the set of predicted results, where such reported results include resource identifiers associated with each predicted result. Alternatively, the reported results may include a subset of the set of predicted results (e.g., the top K resources) as described herein with reference to FIG. 2.

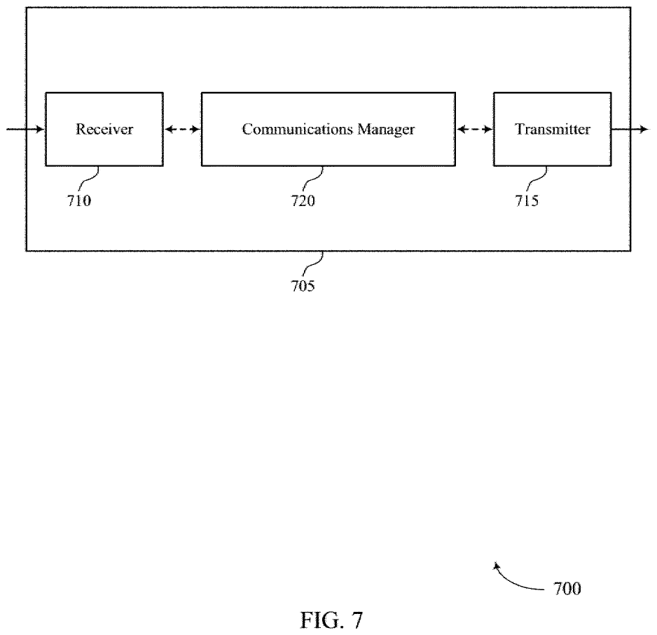

FIG. 7 illustrates a block diagram 700 of a device 705 that supports techniques for efficient signaling for beam prediction in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for efficient signaling for beam prediction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for efficient signaling for beam prediction). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for efficient signaling for beam prediction as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving first control information that indicates generation, by the UE, of a CSI report that includes reported results that pertain to a first set of beams. The communications manager 720 may be configured as or otherwise support a means for receiving second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The communications manager 720 may be configured as or otherwise support a means for measuring the one or more CMRs to obtain a set of measured results, the one or more CMRs determined based on the relationship information. The communications manager 720 may be configured as or otherwise support a means for determining a set of predicted results based on the set of measured results, each of the set of predicted results associated with one of the first set of beams. The communications manager 720 may be configured as or otherwise support a means for transmitting the CSI report with the reported results that are based on at least the set of predicted results.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for indicating relationship information between CMRs and one or more sets of beams, thereby providing for more efficient utilization of communication resources.

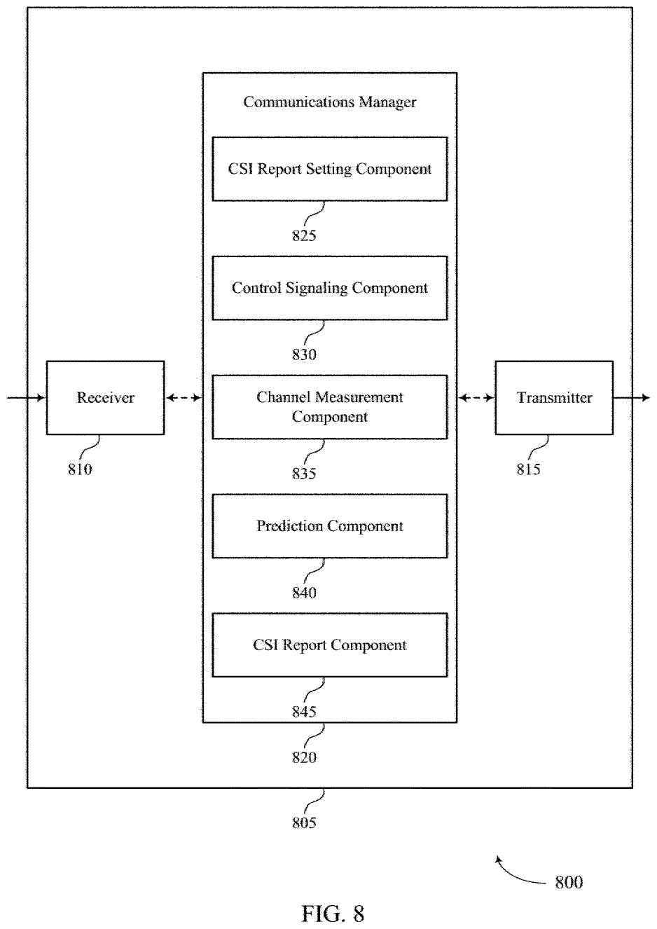

FIG. 8 illustrates a block diagram 800 of a device 805 that supports techniques for efficient signaling for beam prediction in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for efficient signaling for beam prediction). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for efficient signaling for beam prediction). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for efficient signaling for beam prediction as described herein. For example, the communications manager 820 may include a CSI report setting component 825, a control signaling component 830, a channel measurement component 835, a prediction component 840, a CSI report component 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The CSI report setting component 825 may be configured as or otherwise support a means for receiving first control information that indicates generation, by the UE, of a CSI report that includes reported results that pertain to a first set of beams. The control signaling component 830 may be configured as or otherwise support a means for receiving second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The channel measurement component 835 may be configured as or otherwise support a means for measuring the one or more CMRs to obtain a set of measured results, the one or more CMRs determined based on the relationship information. The prediction component 840 may be configured as or otherwise support a means for determining a set of predicted results based on the set of measured results, each of the set of predicted results associated with one of the first set of beams. The CSI report component 845 may be configured as or otherwise support a means for transmitting the CSI report with the reported results that are based on at least the set of predicted results.

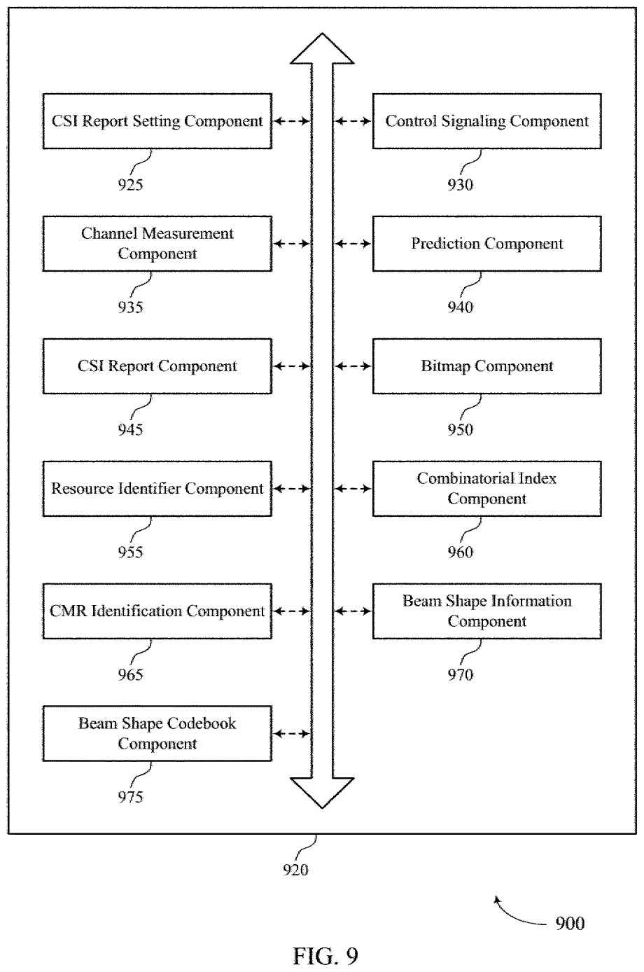

FIG. 9 illustrates a block diagram 900 of a communications manager 920 that supports techniques for efficient signaling for beam prediction in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for efficient signaling for beam prediction as described herein. For example, the communications manager 920 may include a CSI report setting component 925, a control signaling component 930, a channel measurement component 935, a prediction component 940, a CSI report component 945, a bitmap component 950, a resource identifier component 955, a combinatorial index component 960, an CMR identification component 965, a beam shape information component 970, a beam shape codebook component 975, or any combination thereof. Each of these components may communicate, directly or indirectly, with one another (e.g., via one or more buses).

The communications manager 920 may support wireless communication at a UE in accordance with examples as disclosed herein. The CSI report setting component 925 may be configured as or otherwise support a means for receiving first control information that indicates generation, by the UE, of a CSI report that includes reported results that pertain to a first set of beams. The control signaling component 930 may be configured as or otherwise support a means for receiving second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The channel measurement component 935 may be configured as or otherwise support a means for measuring the one or more CMRs to obtain a set of measured results, the one or more CMRs determined based on the relationship information. The prediction component 940 may be configured as or otherwise support a means for determining a set of predicted results based on the set of measured results, each of the set of predicted results associated with one of the first set of beams. The CSI report component 945 may be configured as or otherwise support a means for transmitting the CSI report with the reported results that are based on at least the set of predicted results.

In some examples, to support receiving the second control information, the bitmap component 950 may be configured as or otherwise support a means for receiving, as at least a portion of the relationship information, a bitmap that identifies the one or more CMRs out of the one or more second sets of beams.

In some examples, to support receiving the second control information, the resource identifier component 955 may be configured as or otherwise support a means for receiving, as at least a portion of the relationship information, one or more resource identifiers of the one or more second sets of beams, each of the one or more resource identifiers identifying a respective CMR of the one or more CMRs.

In some examples, to support receiving the second control information, the combinatorial index component 960 may be configured as or otherwise support a means for receiving, as at least a portion of the relationship information, a combinatorial index associated with the one or more second sets of beams. In some examples, to support receiving the second control information, the CMR identification component 965 may be configured as or otherwise support a means for identifying the one or more CMRs out of the one or more second sets of beams in accordance with the combinatorial index.

In some examples, to support receiving the second control information, the control signaling component 930 may be configured as or otherwise support a means for receiving the second control information via a RRC message associated with the one or more CMRs, a MAC-CE message that activates the one or more CMRs, or a separate MAC-CE message that is associated with the CSI report or the one or more CMRs.

In some examples, to support receiving the second control information, the control signaling component 930 may be configured as or otherwise support a means for receiving the second control information via a DCI message that triggers transmission of the CSI report or a separate DCI message that is associated with the CSI report.

In some examples, to support receiving the second control information, the control signaling component 930 may be configured as or otherwise support a means for receiving, as at least a first portion of the relationship information, first relationship information that is indicative of a first relationship between a first set of the one or more second sets of beams and a first portion of the one or more CMRs. In some examples, to support receiving the second control information, the control signaling component 930 may be configured as or otherwise support a means for receiving, as at least a second portion of the relationship information, second relationship information that is indicative of a second relationship between a second set of the one or more second sets of beams and a second portion of the one or more CMRs.

In some examples, the first portion of the relationship information is received via a first CMR control message associated with the first portion of the one or more CMRs and the second portion of the relationship information is received via a second CMR control message associated with the second portion of the one or more CMRs.

In some examples, the first CMR control message is a RRC message associated with the first portion of the one or more CMRs or a MAC-CE message that activates the first portion of the one or more CMRs. In some examples, the second CMR control message is a RRC message associated with the second portion of the one or more CMRs or a MAC-CE message that activates the second portion of the one or more CMRs.

In some examples, the first portion of the relationship information and the second portion of the relationship information are received via a first CMR control message associated with the one or more CMRs.

In some examples, the first CMR control message is a RRC message associated with the one or more CMRs or a MAC-CE message that activates the one or more CMRs and indicates the one or more CMRs being divided into the first portion of the one or more CMRs and the second portion of the one or more CMRs.

In some examples, the first set of the one or more second sets of beams is the same as the first set of beams and. In some examples, the second set of the one or more second sets of beams is the candidate beam shape set of beams that is different from the first set of beams.

In some examples, to support transmitting the CSI report, the CSI report component 945 may be configured as or otherwise support a means for transmitting, as the reported results, each of the set of predicted results and respective resource identifiers, each of the respective resource identifiers corresponding to a respective beam of the first set of beams.

In some examples, to support transmitting the CSI report, the CSI report component 945 may be configured as or otherwise support a means for transmitting, as the reported results, a subset of the set of predicted results and respective resource identifiers, each of the respective resource identifiers corresponding to a respective beam of the first set of beams, where a quantity of the subset of the set of predicted results is based on a threshold quantity.

In some examples, the beam shape information component 970 may be configured as or otherwise support a means for receiving beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, where the relationship between the one or more CMRs and the one or more second sets of beams is based on the beam shape information.

In some examples, to support receiving the beam shape information, the beam shape information component 970 may be configured as or otherwise support a means for receiving an indication of a beam shape codebook that includes the beam shape information, where the beam shape codebook is serving cell-specific or is associated with the first control information and the CSI report.

In some examples, the beam shape codebook includes absolute beam shape candidates or relative beam shape candidates.

In some examples, the beam shape codebook component 975 may be configured as or otherwise support a means for receiving additional control information that identifies codepoints in the beam shape codebook as the one or more CMRs.

In some examples, the first set of beams include synchronization signal blocks, CSI reference signals, or a combination thereof.

In some examples, the set of predicted results include a predicted power associated with each of the first set of beams, a predicted SINR of each of the first set of beams, or both.

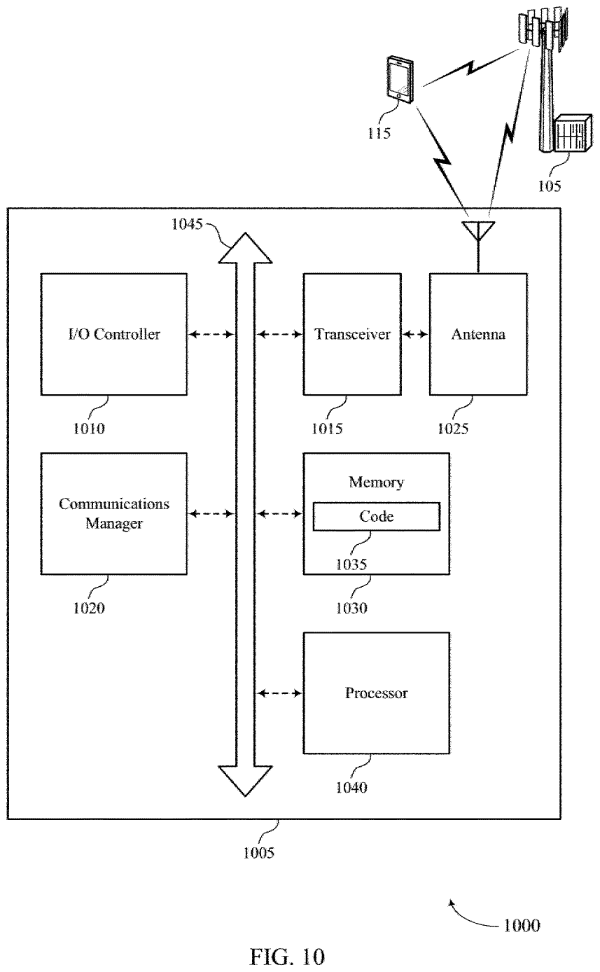

FIG. 10 illustrates a diagram of a system 1000 including a device 1005 that supports techniques for efficient signaling for beam prediction in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for efficient signaling for beam prediction). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving first control information that indicates generation, by the UE, of a CSI report that includes reported results that pertain to a first set of beams. The communications manager 1020 may be configured as or otherwise support a means for receiving second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The communications manager 1020 may be configured as or otherwise support a means for measuring the one or more CMRs to obtain a set of measured results, the one or more CMRs determined based on the relationship information. The communications manager 1020 may be configured as or otherwise support a means for determining a set of predicted results based on the set of measured results, each of the set of predicted results associated with one of the first set of beams. The communications manager 1020 may be configured as or otherwise support a means for transmitting the CSI report with the reported results that are based on at least the set of predicted results.

By including or configuring the communications manager 1020 in accordance with examples as described herein, the device 1005 may support techniques for indicating relationship information between CMRs and one or more sets of beams, thereby providing for more efficient utilization of communication resources and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for efficient signaling for beam prediction as described herein, or the processor 1040 and the memory 1030 may be otherwise configured to perform or support such operations.

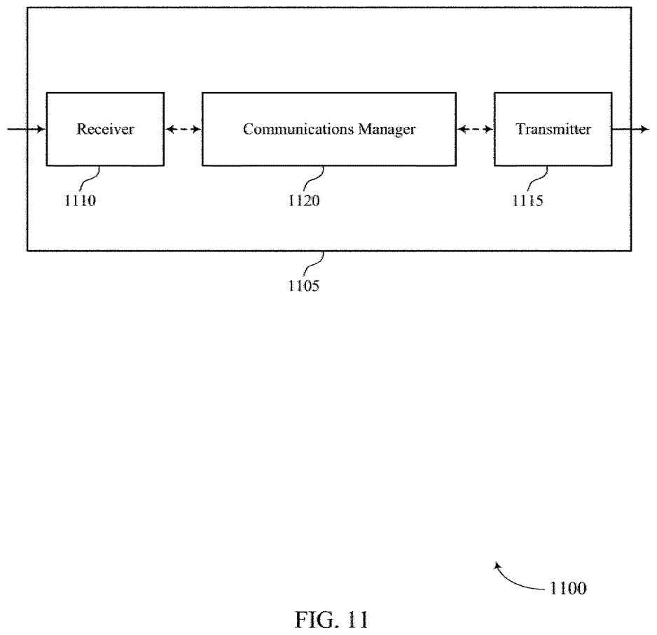

FIG. 11 illustrates a block diagram 1100 of a device 1105 that supports techniques for efficient signaling for beam prediction in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for efficient signaling for beam prediction as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting first control information that indicates generation, by a UE, of a CSI report that includes reported results that pertain to a first set of beams. The communications manager 1120 may be configured as or otherwise support a means for transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The communications manager 1120 may be configured as or otherwise support a means for receiving the CSI report with the reported results that are based on at least a set of predicted results, the set of predicted results being based on a set of measured results of the one or more CMRs, where each of the set of predicted results are associated with one of the first set of beams.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for indicating relationship information between CMRs and one or more sets of beams, thereby providing for more efficient utilization of communication resources.

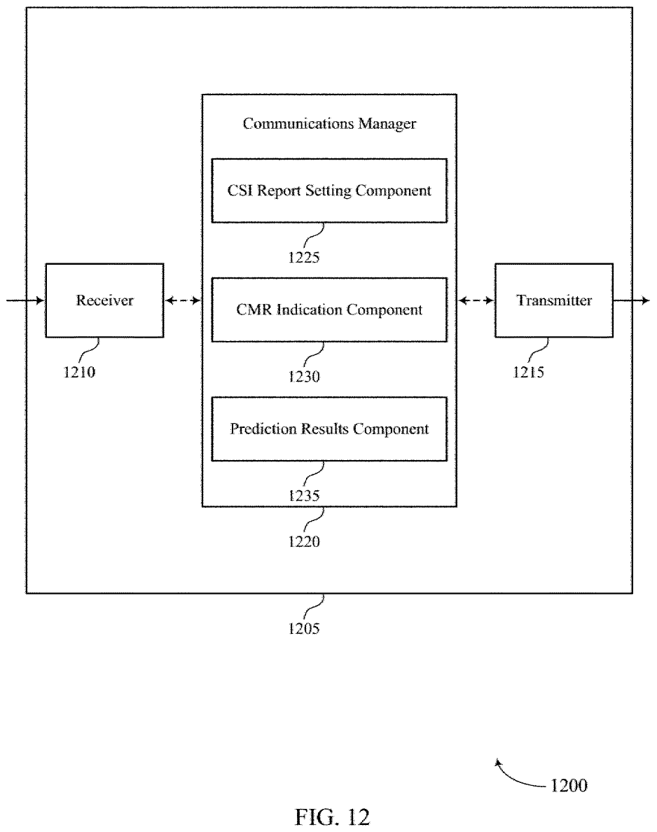

FIG. 12 illustrates a block diagram 1200 of a device 1205 that supports techniques for efficient signaling for beam prediction in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for efficient signaling for beam prediction as described herein. For example, the communications manager 1220 may include a CSI report setting component 1225, an CMR indication component 1230, a prediction results component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The CSI report setting component 1225 may be configured as or otherwise support a means for transmitting first control information that indicates generation, by a UE, of a CSI report that includes reported results that pertain to a first set of beams. The CMR indication component 1230 may be configured as or otherwise support a means for transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The prediction results component 1235 may be configured as or otherwise support a means for receiving the CSI report with the reported results that are based on at least a set of predicted results, the set of predicted results being based on a set of measured results of the one or more CMRs, where each of the set of predicted results are associated with one of the first set of beams.

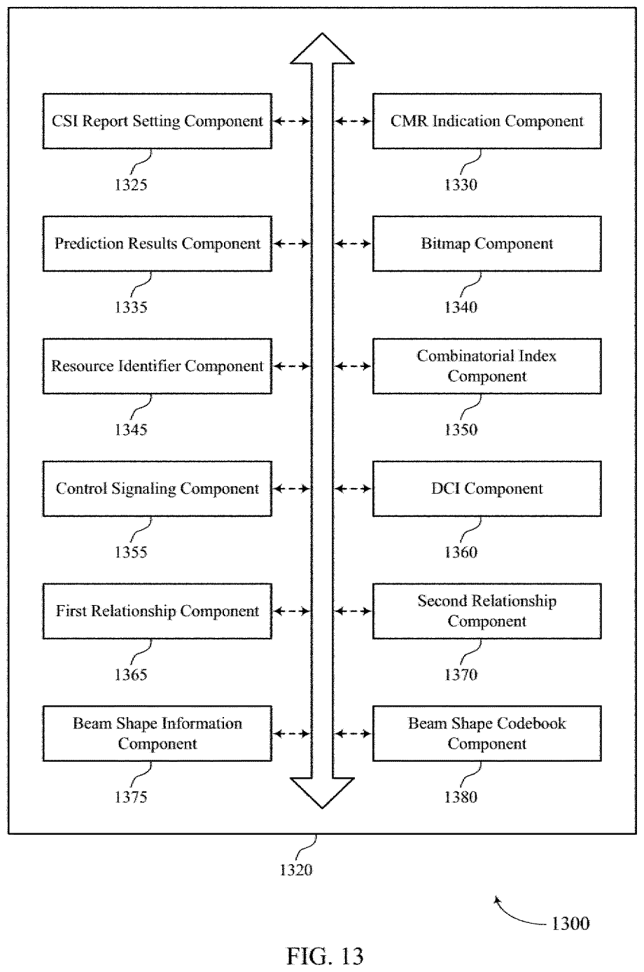

FIG. 13 illustrates a block diagram 1300 of a communications manager 1320 that supports techniques for efficient signaling for beam prediction in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for efficient signaling for beam prediction as described herein. For example, the communications manager 1320 may include a CSI report setting component 1325, an CMR indication component 1330, a prediction results component 1335, a bitmap component 1340, a resource identifier component 1345, a combinatorial index component 1350, a control signaling component 1355, a DCI component 1360, a first relationship component 1365, a second relationship component 1370, a beam shape information component 1375, a beam shape codebook component 1380, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The CSI report setting component 1325 may be configured as or otherwise support a means for transmitting first control information that indicates generation, by a UE, of a CSI report that includes reported results that pertain to a first set of beams. The CMR indication component 1330 may be configured as or otherwise support a means for transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The prediction results component 1335 may be configured as or otherwise support a means for receiving the CSI report with the reported results that are based on at least a set of predicted results, the set of predicted results being based on a set of measured results of the one or more CMRs, where each of the set of predicted results are associated with one of the first set of beams.

In some examples, to support transmitting the second control information, the bitmap component 1340 may be configured as or otherwise support a means for transmitting, as at least a portion of the relationship information, a bitmap that identifies the one or more CMRs out of the one or more second sets of beams.

In some examples, to support transmitting the second control information, the resource identifier component 1345 may be configured as or otherwise support a means for transmitting, as at least a portion of the relationship information, one or more resource identifiers of the one or more second sets of beams, each of the one or more resource identifiers identifying a respective CMR of the one or more CMRs.

In some examples, to support transmitting the second control information, the combinatorial index component 1350 may be configured as or otherwise support a means for transmitting, as at least a portion of the relationship information, a combinatorial index associated with the one or more second sets of beams.

In some examples, to support transmitting the second control information, the control signaling component 1355 may be configured as or otherwise support a means for transmitting the second control information via a RRC message associated with the one or more CMRs, a MAC-CE message that activates the one or more CMRs, or a separate MAC-CE message that is associated with the CSI report or the one or more CMRs.

In some examples, to support transmitting the second control information, the DCI component 1360 may be configured as or otherwise support a means for transmitting the second control information via a DCI message that triggers transmission of the CSI report or a separate DCI message that is associated with the CSI report.

In some examples, to support transmitting the second control information, the first relationship component 1365 may be configured as or otherwise support a means for transmitting, as at least a first portion of the relationship information, first relationship information that is indicative of a first relationship between a first set of the one or more second sets of beams and a first portion of the one or more CMRs. In some examples, to support transmitting the second control information, the second relationship component 1370 may be configured as or otherwise support a means for transmitting, as at least a second portion of the relationship information, second relationship information that is indicative of a second relationship between a second set of the one or more second sets of beams and a second portion of the one or more CMRs.

In some examples, the first portion of the relationship information is received via a first CMR control message associated with the first portion of the one or more CMRs and the second portion of the relationship information is received via a second CMR control message associated with the second portion of the one or more CMRs.

In some examples, the first CMR control message is a RRC message associated with the first portion of the one or more CMRs or a MAC-CE message that activates the first portion of the one or more CMRs. In some examples, the second CMR control message is a RRC message associated with the second portion of the one or more CMRs or a MAC-CE message that activates the second portion of the one or more CMRs.

In some examples, the first portion of the relationship information and the second portion of the relationship information are received via a first CMR control message associated with the one or more CMRs.

In some examples, the first CMR control message is a RRC message associated with the one or more CMRs or a MAC-CE message that activates the one or more CMRs and indicates the one or more CMRs being divided into the first portion of the one or more CMRs and the second portion of the one or more CMRs.

In some examples, the first set of the one or more second sets of beams is the same as the first set of beams and. In some examples, the second set of the one or more second sets of beams is the candidate beam shape set of beams that is different from the first set of beams.

In some examples, to support receiving the CSI report, the prediction results component 1335 may be configured as or otherwise support a means for receiving, as the reported results, each of the set of predicted results and respective resource identifiers, each of the respective resource identifiers corresponding to a respective beam of the first set of beams.

In some examples, to support receiving the CSI report, the prediction results component 1335 may be configured as or otherwise support a means for receiving, as the reported results, a subset of the set of predicted results and respective resource identifiers, each of the respective resource identifiers corresponding to a respective beam of the first set of beams, where a quantity of the subset of the set of predicted results is based on a threshold quantity.

In some examples, the beam shape information component 1375 may be configured as or otherwise support a means for transmitting beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, where the relationship between the one or more CMRs and the one or more second sets of beams is based on the beam shape information.

In some examples, to support transmitting the beam shape information, the beam shape information component 1375 may be configured as or otherwise support a means for transmitting an indication of a beam shape codebook that includes the beam shape information, where the beam shape codebook is serving cell-specific or is associated with the first control information and the CSI report.

In some examples, the beam shape codebook includes absolute beam shape candidates or relative beam shape candidates.

In some examples, the beam shape codebook component 1380 may be configured as or otherwise support a means for transmitting additional control information that identifies codepoints in the beam shape codebook as the one or more CMRs.

In some examples, the first set of beams include synchronization signal blocks, CSI reference signals, or a combination thereof.

In some examples, the set of predicted results include a predicted power associated with each of the first set of beams, a predicted SINR of each of the first set of beams, or both.

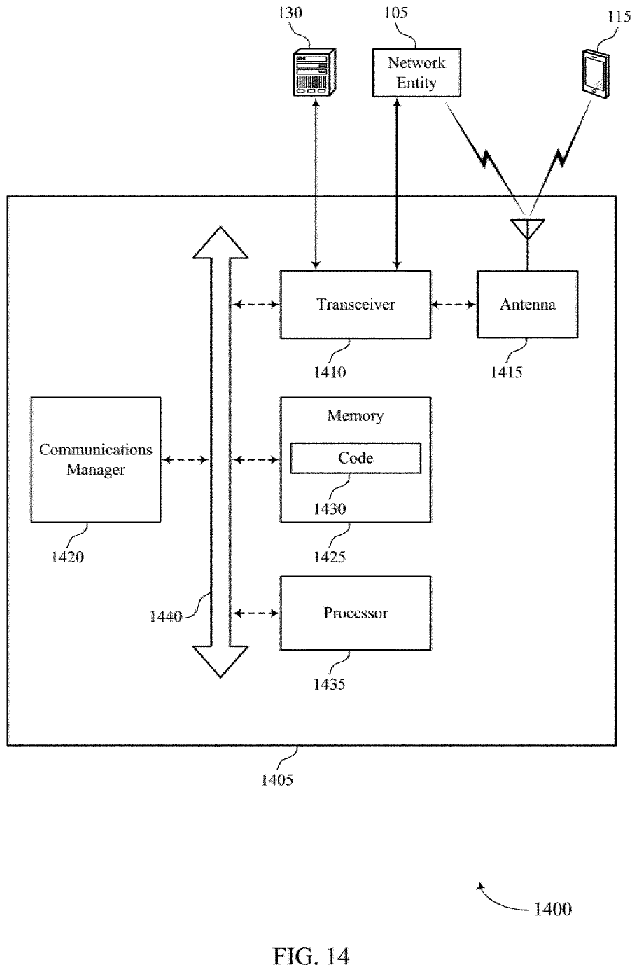

FIG. 14 illustrates a diagram of a system 1400 including a device 1405 that supports techniques for efficient signaling for beam prediction in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for efficient signaling for beam prediction). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting first control information that indicates generation, by a UE, of a CSI report that includes reported results that pertain to a first set of beams. The communications manager 1420 may be configured as or otherwise support a means for transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The communications manager 1420 may be configured as or otherwise support a means for receiving the CSI report with the reported results that are based on at least a set of predicted results, the set of predicted results being based on a set of measured results of the one or more CMRs, where each of the set of predicted results are associated with one of the first set of beams.

By including or configuring the communications manager 1420 in accordance with examples as described herein, the device 1405 may support techniques for indicating relationship information between CMRs and one or more sets of beams, thereby providing for more efficient utilization of communication resources and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of techniques for efficient signaling for beam prediction as described herein, or the processor 1435 and the memory 1425 may be otherwise configured to perform or support such operations.

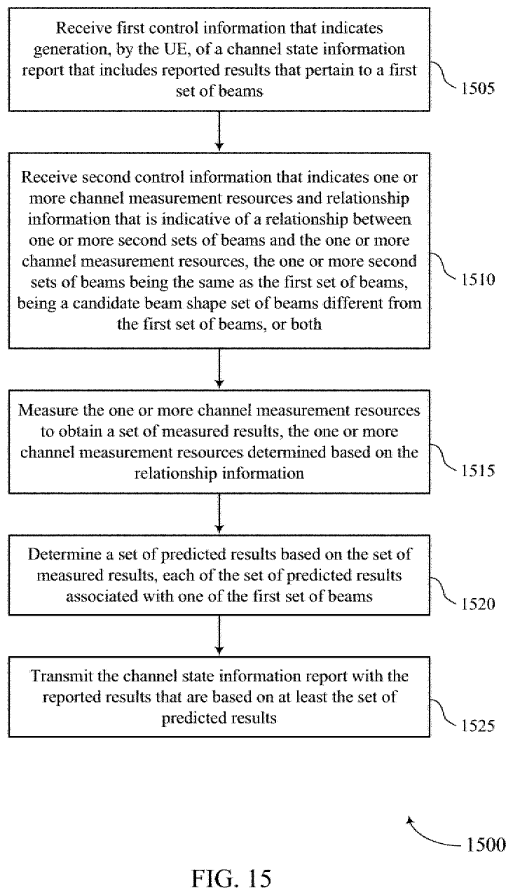

FIG. 15 illustrates a flowchart showing a method 1500 that supports techniques for efficient signaling for beam prediction in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving first control information that indicates generation, by the UE, of a CSI report that includes reported results that pertain to a first set of beams. The operations of 1505 may be performed in accordance with examples as disclosed herein. In some examples, aspects of the operations of 1505 may be performed by a CSI report setting component 925 as described with reference to FIG. 9.

At 1510, the method may include receiving second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The operations of 1510 may be performed in accordance with examples as disclosed herein. In some examples, aspects of the operations of 1510 may be performed by a control signaling component 930 as described with reference to FIG. 9.

At 1515, the method may include measuring the one or more CMRs to obtain a set of measured results, the one or more CMRs determined based on the relationship information. The operations of 1515 may be performed in accordance with examples as disclosed herein. In some examples, aspects of the operations of 1515 may be performed by a channel measurement component 935 as described with reference to FIG. 9.

At 1520, the method may include determining a set of predicted results based on the set of measured results, each of the set of predicted results associated with one of the first set of beams. The operations of 1520 may be performed in accordance with examples as disclosed herein. In some examples, aspects of the operations of 1520 may be performed by a prediction component 940 as described with reference to FIG. 9.

At 1525, the method may include transmitting the CSI report with the reported results that are based on at least the set of predicted results. The operations of 1525 may be performed in accordance with examples as disclosed herein. In some examples, aspects of the operations of 1525 may be performed by a CSI report component 945 as described with reference to FIG. 9.

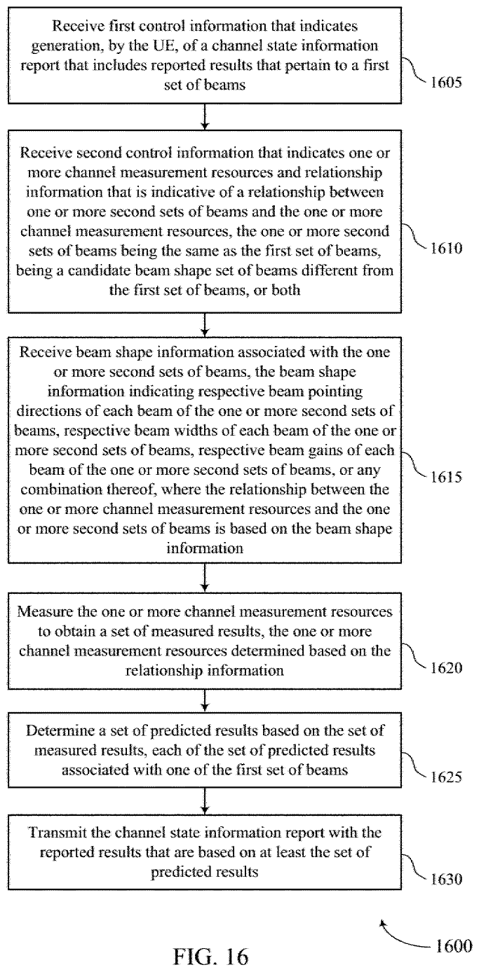

FIG. 16 illustrates a flowchart showing a method 1600 that supports techniques for efficient signaling for beam prediction in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving first control information that indicates generation, by the UE, of a channel state information report that includes reported results that pertain to a first set of beams. The operations of 1605 may be performed in accordance with examples as disclosed herein. In some examples, aspects of the operations of 1605 may be performed by a CSI report setting component 925 as described with reference to FIG. 9.

At 1610, the method may include receiving second control information that indicates one or more channel measurement resources and relationship information that is indicative of a relationship between one or more second sets of beams and the one or more channel measurement resources, the one or more second sets of beams being the same as the first set of beams, being a candidate beam shape set of beams different from the first set of beams, or both. The operations of 1610 may be performed in accordance with examples as disclosed herein. In some examples, aspects of the operations of 1610 may be performed by a control signaling component 930 as described with reference to FIG. 9.

At 1615, the method may include receiving beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, where the relationship between the one or more channel measurement resources and the one or more second sets of beams is based on the beam shape information. The operations of 1615 may be performed in accordance with examples as disclosed herein. In some examples, aspects of the operations of 1615 may be performed by a beam shape information component 970 as described with reference to FIG. 9.

At 1620, the method may include measuring the one or more channel measurement resources to obtain a set of measured results, the one or more channel measurement resources determined based on the relationship information. The operations of 1620 may be performed in accordance with examples as disclosed herein. In some examples, aspects of the operations of 1620 may be performed by a channel measurement component 935 as described with reference to FIG. 9.

At 1625, the method may include determining a set of predicted results based on the set of measured results, each of the set of predicted results associated with one of the first set of beams. The operations of 1625 may be performed in accordance with examples as disclosed herein. In some examples, aspects of the operations of 1625 may be performed by a prediction component 940 as described with reference to FIG. 9.

At 1630, the method may include transmitting the channel state information report with the reported results that are based on at least the set of predicted results. The operations of 1630 may be performed in accordance with examples as disclosed herein. In some examples, aspects of the operations of 1630 may be performed by a CSI report component 945 as described with reference to FIG. 9.

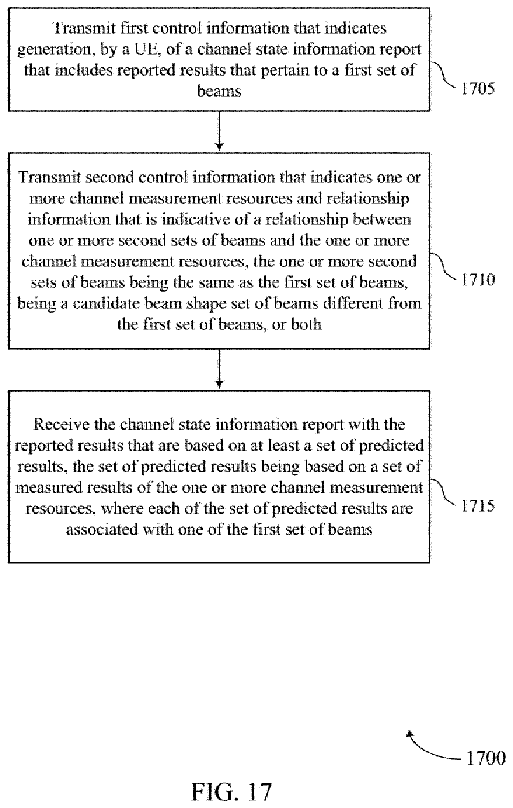

FIG. 17 illustrates a flowchart showing a method 1700 that supports techniques for efficient signaling for beam prediction in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first control information that indicates generation, by a UE, of a CSI report that includes reported results that pertain to a first set of beams. The operations of 1705 may be performed in accordance with examples as disclosed herein. In some examples, aspects of the operations of 1705 may be performed by a CSI report setting component 1325 as described with reference to FIG. 13.

At 1710, the method may include transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The operations of 1710 may be performed in accordance with examples as disclosed herein. In some examples, aspects of the operations of 1710 may be performed by an CMR indication component 1330 as described with reference to FIG. 13.

At 1715, the method may include receiving the CSI report with the reported results that are based on at least a set of predicted results, the set of predicted results being based on a set of measured results of the one or more CMRs, where each of the set of predicted results are associated with one of the first set of beams. The operations of 1715 may be performed in accordance with examples as disclosed herein. In some examples, aspects of the operations of 1715 may be performed by a prediction results component 1335 as described with reference to FIG. 13.

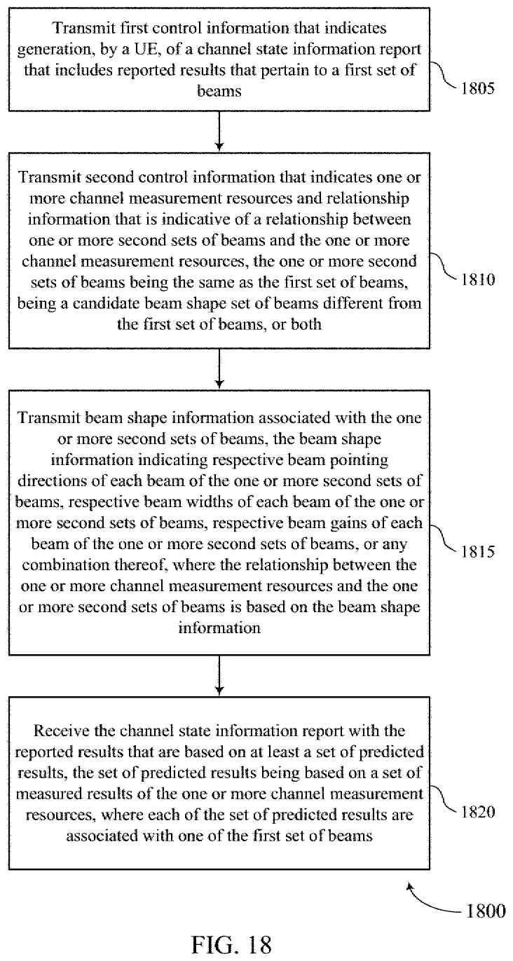

FIG. 18 illustrates a flowchart showing a method 1800 that supports techniques for efficient signaling for beam prediction in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting first control information that indicates generation, by a UE, of a CSI report that includes reported results that pertain to a first set of beams. The operations of 1805 may be performed in accordance with examples as disclosed herein. In some examples, aspects of the operations of 1805 may be performed by a CSI report setting component 1325 as described with reference to FIG. 13.

At 1810, the method may include transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both. The operations of 1810 may be performed in accordance with examples as disclosed herein. In some examples, aspects of the operations of 1810 may be performed by an CMR indication component 1330 as described with reference to FIG. 13.

At 1815, the method may include transmitting beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, where the relationship between the one or more CMRs and the one or more second sets of beams is based on the beam shape information. The operations of 1815 may be performed in accordance with examples as disclosed herein. In some examples, aspects of the operations of 1815 may be performed by a beam shape information component 1375 as described with reference to FIG. 13.

At 1820, the method may include receiving the CSI report with the reported results that are based on at least a set of predicted results, the set of predicted results being based on a set of measured results of the one or more CMRs, where each of the set of predicted results are associated with one of the first set of beams. The operations of 1820 may be performed in accordance with examples as disclosed herein. In some examples, aspects of the operations of 1820 may be performed by a prediction results component 1335 as described with reference to FIG. 13.

The following provides an overview of aspects of the present disclosure:

Aspect 1: A method for wireless communication at a UE, comprising: receiving first control information that indicates generation, by the UE, of a CSI report that includes reported results that pertain to a first set of beams; receiving second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both; measuring the one or more CMRs to obtain a set of measured results, the one or more CMRs determined based at least in part on the relationship information; determining a set of predicted results based at least in part on the set of measured results, each of the set of predicted results associated with one of the first set of beams; and transmitting the CSI report with the reported results that are based on at least the set of predicted results.

Aspect 2: The method of aspect 1, wherein receiving the second control information comprises: receiving, as at least a portion of the relationship information, a bitmap that identifies the one or more CMRs out of the one or more second sets of beams.

Aspect 3: The method of any of aspects 1 through 2, wherein receiving the second control information comprises: receiving, as at least a portion of the relationship information, one or more resource identifiers of the one or more second sets of beams, each of the one or more resource identifiers identifying a respective CMR of the one or more CMRs.

Aspect 4: The method of any of aspects 1 through 3, wherein receiving the second control information comprises: receiving, as at least a portion of the relationship information, a combinatorial index associated with the one or more second sets of beams; and identifying the one or more CMRs out of the one or more second sets of beams in accordance with the combinatorial index.

Aspect 5: The method of any of aspects 1 through 4, wherein receiving the second control information comprises: receiving the second control information via a RRC message associated with the one or more CMRs, a MAC-CE message that activates the one or more CMRs, or a separate MAC-CE message that is associated with the CSI report or the one or more CMRs.

Aspect 6: The method of any of aspects 1 through 5, wherein receiving the second control information comprises: receiving the second control information via a DCI message that triggers transmission of the CSI report or a separate DCI message that is associated with the CSI report.

Aspect 7: The method of any of aspects 1 through 6, wherein receiving the second control information comprises: receiving, as at least a first portion of the relationship information, first relationship information that is indicative of a first relationship between a first set of the one or more second sets of beams and a first portion of the one or more CMRs; and receiving, as at least a second portion of the relationship information, second relationship information that is indicative of a second relationship between a second set of the one or more second sets of beams and a second portion of the one or more CMRs.

Aspect 8: The method of aspect 7, wherein the first portion of the relationship information is received via a first CMR control message associated with the first portion of the one or more CMRs and the second portion of the relationship information is received via a second CMR control message associated with the second portion of the one or more CMRs.

Aspect 9: The method of aspect 8, wherein the first CMR control message is a RRC message associated with the first portion of the one or more CMRs or a MAC-CE message that activates the first portion of the one or more CMRs, and the second CMR control message is a RRC message associated with the second portion of the one or more CMRs or a MAC-CE message that activates the second portion of the one or more CMRs.

Aspect 10: The method of any of aspects 7 through 9, wherein the first portion of the relationship information and the second portion of the relationship information are received via a first CMR control message associated with the one or more CMRs.

Aspect 11: The method of aspect 10, wherein the first CMR control message is a RRC message associated with the one or more CMRs or a MAC-CE message that activates the one or more CMRs and indicates the one or more CMRs being divided into the first portion of the one or more CMRs and the second portion of the one or more CMRs.

Aspect 12: The method of any of aspects 7 through 11, wherein the first set of the one or more second sets of beams is the same as the first set of beams and the second set of the one or more second sets of beams is the candidate beam shape set of beams that is different from the first set of beams.

Aspect 13: The method of any of aspects 1 through 12, wherein transmitting the CSI report comprises: transmitting, as the reported results, each of the set of predicted results and respective resource identifiers, each of the respective resource identifiers corresponding to a respective beam of the first set of beams.

Aspect 14: The method of any of aspects 1 through 13, wherein transmitting the CSI report comprises: transmitting, as the reported results, a subset of the set of predicted results and respective resource identifiers, each of the respective resource identifiers corresponding to a respective beam of the first set of beams, wherein a quantity of the subset of the set of predicted results is based on a threshold quantity.

Aspect 15: The method of any of aspects 1 through 14, further comprising: receiving beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, wherein the relationship between the one or more CMRs and the one or more second sets of beams is based at least in part on the beam shape information.

Aspect 16: The method of aspect 15, wherein receiving the beam shape information comprises: receiving an indication of a beam shape codebook that includes the beam shape information, wherein the beam shape codebook is serving cell-specific or is associated with the first control information and the CSI report.

Aspect 17: The method of aspect 16, wherein the beam shape codebook includes absolute beam shape candidates or relative beam shape candidates.

Aspect 18: The method of any of aspects 16 through 17, further comprising: receiving additional control information that identifies codepoints in the beam shape codebook as the one or more CMRs.

Aspect 19: The method of any of aspects 1 through 18, wherein the first set of beams comprise SSBs, CSI-RSs, or a combination thereof.

Aspect 20: The method of any of aspects 1 through 19, wherein the set of predicted results comprise a predicted power associated with each of the first set of beams, a predicted SINR of each of the first set of beams, or both.

Aspect 21: A method for wireless communication at a network entity, comprising: transmitting first control information that indicates generation, by a UE, of a CSI report that includes reported results that pertain to a first set of beams; transmitting second control information that indicates one or more CMRs and relationship information that is indicative of a relationship between one or more second sets of beams and the one or more CMRs, the one or more second sets of beams being the same as the first set of beams, being a candidate beam shape set of beams different from the first set of beams, or both; and receiving the CSI report with the reported results that are based on at least a set of predicted results, the set of predicted results being based at least in part on a set of measured results of the one or more CMRs, wherein each of the set of predicted results are associated with one of the first set of beams.

Aspect 22: The method of aspect 21, wherein transmitting the second control information comprises: transmitting, as at least a portion of the relationship information, a bitmap that identifies the one or more CMRs out of the one or more second sets of beams.

Aspect 23: The method of any of aspects 21 through 22, wherein transmitting the second control information comprises: transmitting, as at least a portion of the relationship information, one or more resource identifiers of the one or more second sets of beams, each of the one or more resource identifiers identifying a respective CMR of the one or more CMRs.

Aspect 24: The meth od of any of aspects 21 through 23, wherein transmitting the second control information comprises: transmitting, as at least a portion of the relationship information, a combinatorial index associated with the one or more second sets of beams.

Aspect 25: The method of any of aspects 21 through 24, wherein transmitting the second control information comprises: transmitting the second control information via a RRC message associated with the one or more CMRs, a MAC-CE message that activates the one or more CMRs, or a separate MAC-CE message that is associated with the CSI report or the one or more CMRs.

Aspect 26: The method of any of aspects 21 through 25, wherein transmitting the second control information comprises: transmitting the second control information via a DCI message that triggers transmission of the CSI report or a separate DCI message that is associated with the CSI report.

Aspect 27: The method of any of aspects 21 through 26, wherein transmitting the second control information comprises: transmitting, as at least a first portion of the relationship information, first relationship information that is indicative of a first relationship between a first set of the one or more second sets of beams and a first portion of the one or more CMRs; and transmitting, as at least a second portion of the relationship information, second relationship information that is indicative of a second relationship between a second set of the one or more second sets of beams and a second portion of the one or more CMRs.

Aspect 28: The method of aspect 27, wherein the first portion of the relationship information is received via a first CMR control message associated with the first portion of the one or more CMRs and the second portion of the relationship information is received via a second CMR control message associated with the second portion of the one or more CMRs.

Aspect 29: The method of aspect 28, wherein the first CMR control message is a RRC message associated with the first portion of the one or more CMRs or a MAC-CE message that activates the first portion of the one or more CMRs, and the second CMR control message is a RRC message associated with the second portion of the one or more CMRs or a MAC-CE message that activates the second portion of the one or more CMRs.

Aspect 30: The method of any of aspects 27 through 29, wherein the first portion of the relationship information and the second portion of the relationship information are received via a first CMR control message associated with the one or more CMRs.

Aspect 31: The method of aspect 30, wherein the first CMR control message is a RRC message associated with the one or more CMRs or a MAC-CE message that activates the one or more CMRs and indicates the one or more CMRs being divided into the first portion of the one or more CMRs and the second portion of the one or more CMRs.

Aspect 32: Th e method of any of aspects 27 through 31, wherein the first set of the one or more second sets of beams is the same as the first set of beams and the second set of the one or more second sets of beams is the candidate beam shape set of beams that is different from the first set of beams.

Aspect 33: Th e method of any of aspects 21 through 32, wherein receiving the CSI report comprises: receiving, as the reported results, each of the set of predicted results and respective resource identifiers, each of the respective resource identifiers corresponding to a respective beam of the first set of beams.

Aspect 34: The method of any of aspects 21 through 33, wherein receiving the CSI report comprises: receiving, as the reported results, a subset of the set of predicted results and respective resource identifiers, each of the respective resource identifiers corresponding to a respective beam of the first set of beams, wherein a quantity of the subset of the set of predicted results is based on a threshold quantity.

Aspect 35: The method of any of aspects 21 through 34, further comprising: transmitting beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, wherein the relationship between the one or more CMRs and the one or more second sets of beams is based at least in part on the beam shape information.
Aspect 36: The method of aspect 35, wherein transmitting the beam shape information comprises: transmitting an indication of a beam shape codebook that includes the beam shape information, wherein the beam shape codebook is serving cell-specific or is associated with the first control information and the CSI report.

Aspect 37: The method of aspect 36, wherein the beam shape codebook includes absolute beam shape candidates or relative beam shape candidates.

Aspect 38: The method of any of aspects 36 through 37, further comprising: transmitting additional control information that identifies codepoints in the beam shape codebook as the one or more CMRs.

Aspect 39: The method of any of aspects 21 through 38, wherein the first set of beams comprise SSB, CSI-RSs, or a combination thereof.

Aspect 40: The method of any of aspects 21 through 39, wherein the set of predicted results comprise a predicted power associated with each of the first set of beams, a predicted SINR of each of the first set of beams, or both.

Aspect 41: An apparatus for wireless communication at a UE, comprising a processor; memory coupled with the processor; and instructions stored in the memory and executable by the processor to cause the apparatus to perform a method of any of aspects 1 through 20.

Aspect 42: An apparatus for wireless communication at a UE, comprising at least one means for performing a method of any of aspects 1 through 20.

Aspect 43: A non-transitory computer-readable medium storing code for wireless communication at a UE, the code comprising instructions executable by a processor to perform a method of any of aspects 1 through 20.

Aspect 44: An apparatus for wireless communication at a network entity, comprising a processor; memory coupled with the processor; and instructions stored in the memory and executable by the processor to cause the apparatus to perform a method of any of aspects 21 through 40.

Aspect 45: An apparatus for wireless communication at a network entity, comprising at least one means for performing a method of any of aspects 21 through 40.

Aspect 46: A non-transitory computer-readable medium storing code for wireless communication at a network entity, the code comprising instructions executable by a processor to perform a method of any of aspects 21 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
a processor;
memory coupled with the processor; and
instructions stored in the memory and executable by the processor to cause the apparatus to:
receive first control information that indicates generation, by the apparatus, of a channel state information report that includes reported results that pertain to a first set of beams;
receive second control information that indicates one or more channel measurement resources and relationship information that is indicative of a relationship between one or more second sets of beams and the one or more channel measurement resources, the one or more second sets of beams being the same as the first set of beams, being a candidate beam shape set of beams different from the first set of beams, or both;
measure the one or more channel measurement resources to obtain a set of measured results, the one or more channel measurement resources determined based at least in part on the relationship information;
determine a set of predicted results based at least in part on the set of measured results, each of the set of predicted results associated with one of the first set of beams; and
transmit the channel state information report with the reported results that are based on at least the set of predicted results.

2. The apparatus of claim 1, wherein the instructions to receive the second control information are executable by the processor to cause the apparatus to:
receive, as at least a portion of the relationship information, a bitmap that identifies the one or more channel measurement resources out of the one or more second sets of beams.

3. The apparatus of claim 1, wherein the instructions to receive the second control information are executable by the processor to cause the apparatus to:
receive, as at least a portion of the relationship information, one or more resource identifiers of the one or more second sets of beams, each of the one or more resource identifiers identifying a respective channel measurement resource of the one or more channel measurement resources.

4. The apparatus of claim 1, wherein the instructions to receive the second control information are executable by the processor to cause the apparatus to:
receive, as at least a portion of the relationship information, a combinatorial index associated with the one or more second sets of beams; and
identify the one or more channel measurement resources out of the one or more second sets of beams in accordance with the combinatorial index.

5. The apparatus of claim 1, wherein the instructions to receive the second control information are executable by the processor to cause the apparatus to:
receive the second control information via a radio resource control message associated with the one or more channel measurement resources, a medium access control-control element message that activates the one or more channel measurement resources, or a separate medium access control-control element message that is associated with the channel state information report or the one or more channel measurement resources.

6. The apparatus of claim 1, wherein the instructions to receive the second control information are executable by the processor to cause the apparatus to:
receive the second control information via a downlink control information message that triggers transmission of the channel state information report or a separate downlink control information message that is associated with the channel state information report.

7. The apparatus of claim 1, wherein the instructions to receive the second control information are executable by the processor to cause the apparatus to:
receive, as at least a first portion of the relationship information, first relationship information that is indicative of a first relationship between a first set of the one or more second sets of beams and a first portion of the one or more channel measurement resources; and
receive, as at least a second portion of the relationship information, second relationship information that is indicative of a second relationship between a second set of the one or more second sets of beams and a second portion of the one or more channel measurement resources.

8. The apparatus of claim 7, wherein the first portion of the relationship information is received via a first channel measurement resource control message associated with the first portion of the one or more channel measurement resources and the second portion of the relationship information is received via a second channel measurement resource control message associated with the second portion of the one or more channel measurement resources.

9. The apparatus of claim 8, wherein:
the first channel measurement resource control message is a radio resource control message associated with the first portion of the one or more channel measurement resources or a medium access control-control element message that activates the first portion of the one or more channel measurement resources, and
the second channel measurement resource control message is a radio resource control message associated with the second portion of the one or more channel measurement resources or a medium access control-control element message that activates the second portion of the one or more channel measurement resources.

10. The apparatus of claim 7, wherein the first portion of the relationship information and the second portion of the relationship information are received via a first channel measurement resource control message associated with the one or more channel measurement resources.

11. The apparatus of claim 10, wherein the first channel measurement resource control message is a radio resource control message associated with the one or more channel measurement resources or a medium access control-control element message that activates the one or more channel measurement resources and indicates the one or more channel measurement resources being divided into the first portion of the one or more channel measurement resources and the second portion of the one or more channel measurement resources.

12. (canceled)

13. The apparatus of claim 1, wherein the instructions to transmit the channel state information report are executable by the processor to cause the apparatus to:
transmit, as the reported results, each of the set of predicted results and respective resource identifiers, each of the respective resource identifiers corresponding to a respective beam of the first set of beams.

14. The apparatus of claim 1, wherein the instructions to transmit the channel state information report are executable by the processor to cause the apparatus to:
transmit, as the reported results, a subset of the set of predicted results and respective resource identifiers, each of the respective resource identifiers corresponding to a respective beam of the first set of beams, wherein a quantity of the subset of the set of predicted results is based on a threshold quantity.

15. The apparatus of claim 1, wherein the instructions are further executable by the processor to cause the apparatus to:
receive beam shape information associated with the one or more second sets of beams, the beam shape information indicating respective beam pointing directions of each beam of the one or more second sets of beams, respective beam widths of each beam of the one or more second sets of beams, respective beam gains of each beam of the one or more second sets of beams, or any combination thereof, wherein the relationship between the one or more channel measurement resources and the one or more second sets of beams is based at least in part on the beam shape information.

16. The apparatus of claim 15, wherein the instructions to receive the beam shape information are executable by the processor to cause the apparatus to:
receive an indication of a beam shape codebook that includes the beam shape information, wherein the beam shape codebook is serving cell-specific or is associated with the first control information and the channel state information report.

17. (canceled)

18. The apparatus of claim 16, wherein the instructions are further executable by the processor to cause the apparatus to:
receive additional control information that identifies codepoints in the beam shape codebook as the one or more channel measurement resources.

19. The apparatus of claim 1, wherein the first set of beams comprise synchronization signal blocks, channel state information reference signals, or a combination thereof.

20. The apparatus of claim 1, wherein the set of predicted results comprise a predicted power associated with each of the first set of beams, a predicted signal to noise ratio of each of the first set of beams, or both.

21. An apparatus for wireless communication, comprising:
a processor,
memory coupled with the processor; and
instructions stored in the memory and executable by the processor to cause the apparatus to:
transmit first control information that indicates generation, by a user equipment (UE), of a channel state information report that includes reported results that pertain to a first set of beams;
transmit second control information that indicates one or more channel measurement resources and relationship information that is indicative of a relationship between one or more second sets of beams and the one or more channel measurement resources, the one or more second sets of beams being the same as the first set of beams, being a candidate beam shape set of beams different from the first set of beams, or both; and
receive the channel state information report with the reported results that are based on at least a set of predicted results, the set of predicted results being based at least in part on a set of measured results of the one or more channel measurement resources, wherein each of the set of predicted results are associated with one of the first set of beams,

22-28. (canceled)

29. A method for wireless communication at a user equipment (UE), comprising:
receiving first control information that indicates generation, by the UE, of a channel state information report that includes reported results that pertain to a first set of beams;
receiving second control information that indicates one or more channel measurement resources and relationship information that is indicative of a relationship between one or more second sets of beams and the one or more channel measurement resources, the one or more second sets of beams being the same as the first set of beams, being a candidate beam shape set of beams different from the first set of beams, or both,
measuring the one or more channel measurement resources to obtain a set of measured results, the one or more channel measurement resources determined based at least in part on the relationship information;
determining a set of predicted results based at least in part on the set of measured results, each of the set of predicted results associated with one of the first set of beams; and
transmitting the channel state information report with the reported results that are based on at least the set of predicted results.

30. (canceled)
